(19) United States
(12) Patent Application Publication
(10) Pub. No.: US 2026/0254370 A1
(43) Pub. Date: Aug. 27, 2026

(54) PHASE-SHIFT MODULATED FULL-BRIDGE POWER INVERTERS AND METHODS OF OPERATION THEREOF

(71) Applicants: NANYANG TECHNOLOGICAL UNIVERSITY, Singapore (SG); THE HONG KONG POLYTECHNIC UNIVERSITY, Hong Kong (CN)

(72) Inventors: Shu Yuen Ron HUI, Singapore (SG); Yun YANG, Hong Kong (CN)

(21) Appl. No.: 18/864,790

(22) PCT Filed: Apr. 12, 2023
(86) PCT No.: PCT/SG2023/050248

§ 371 Date: Nov. 11, 2024

(30) Foreign Application Priority Data
May 13, 2022 (SG) 10202205045V

(51) Int. Cl. H02M 7/5387; H02J 50/00; H02M 1/00; H02M 7/48

(52) U.S. Cl. CPC H02M 7/53871; H02J 50/00; H02M 1/0043; H02M 1/0058; H02M 7/4815

(57) ABSTRACT

A phase-shift modulated full-bridge power inverter comprises: a leading bridge leg comprising: a first power switch having a first power switch parasitic capacitance; and a second power switch having a second power switch parasitic capacitance. A lagging bridge leg comprises a third power switch having third power switch parasitic capacitance; and a fourth power switch having a fourth power switch parasitic capacitance. Each of the power 10 switches is switched on and off in a switching cycle. An augmented passive circuit comprises an inductor which combines with the third power switch parasitic capacitance and the fourth power switch capacitance to form a resonator when a first one of the third and fourth power switches is switched off and a second one of the third and fourth power switches is in a switched off state. Energy stored in the parasitic capacitance of the second one of the third 15 and fourth power switches is discharged before the second one of the third and fourth power switches is switched on.

### TECHNICAL FIELD

The invention relates generally to the field of power electronics, more particularly to transfer power wirelessly. Aspects of the invention relate to a phase-shift modulated full-bridge power inverter configured for use in a wireless power transfer system. Another aspect of the invention relates to a method of operating a phase-shift modulated full-bridge power inverter in a wireless power transfer system. Another aspect of the invention relates to a method of fitting an augmented passive circuit to a phase-shift modulated full-bridge power inverter configured for use in a wireless power transfer system. Another aspect of the invention relates to a kit of augmented passive circuit parts for fitting to a phase-shift modulated full-bridge power inverter configured for use in a wireless power transfer system.

In this respect, it is worth noting the term “augmented passive circuit” is used in the sense that no active switches are required in the augmented passive circuit.

One aspect of the invention has particular, but not exclusive, application in reducing power loss in the power inverter. For instance, use of the techniques disclosed herein may allow for the power inverter to enable all power switches in a wireless power transfer power inverter to be soft-switched for all operating regions. Use of the techniques disclosed herein may allow for zero-voltage switching (ZVS) to be achieved in all of the power switches of the power inverter for all load conditions, without the need for coordinated control and communication with the receiver circuit.

### BACKGROUND

With improvements of switching speeds and power capabilities, power electronic devices such as power metal-oxide-semiconductor field-effect-transistors (MOSFETs) and insulated gate bipolar transistors (IGBT) have been widely used in electrical energy conversion. Recent advances in wide-band-gap (WBG) semiconductor technology further enhance the switching frequency range and power ratings of these power devices. Power converters based on power electronics technology can switch at hundreds of kilo-Hertz in commercial switched mode power supplies (SMPS) and are being considered for switching up to tens of Mega-Hertz for some emerging applications such as wireless power transfer (WPT).

A major limitation on the switching frequency is the switching power loss in the power switches of a power converter. During the turn-on and turn-off processes, the instantaneous voltage across and the current in the power switch change with time. The instantaneous product of this transient voltage and current contribute to the switching power loss of such power switch. The switching power loss results in heat loss and thermal stress on the structure of the power switch. The large rate of change of voltage (dv/dt) and rate of change of current (di/dt) also contribute to electromagnetic interference (EMI). Traditional switching methods without reducing the switching power loss is called “hard-switching” techniques. In the previous two decades, “soft-switching” methods have been developed and used for many power converters and power inverters. Soft-switching methods create zero voltage and/or zero current for the power switch during the turn-on and turn-off transient process so that the switching loss can ideally be eliminated. Soft-switching techniques can be classified as zero-voltage switching (ZVS) and zero-current switching (ZCS).

Soft-switching techniques for half-bridge and full-bridge power inverters, under 50% duty-cycle pulse-width-modulation (PWM) control, were reported in the 1980s and 1990s in several seminal papers [1]-[3]. Switching the inverter at an operating frequency that falls into the inductive region of the load impedance can ensure ZVS on the condition that the load current is continuous. Under light load condition, the load current becomes discontinuous and ZVS condition is lost. This problem can be solved by adding an augmented inductive-capacitor (LC) circuit branch across the load to maintain a minimum continuous current to ensure ZVS [4].

For full-bridge power inverters under phase-shift modulation (PSM) control, discontinuous current occurs when the phase-shift angle is large (e.g., above 150°). Adding an additional LC circuit branch cannot achieve ZVS. This well-known problem has been a major technical challenge that has not yielded a good solution despite several proposals being made in the past. A recent review paper [5] provides a comprehensive coverage of various forms of symmetric PWM phase-shift converters [6] and asymmetric PWM phase-shift converters [7] with high-frequency isolation transformers for dc/dc power conversion. That said, the phase-shift converters in [6] and [7] were proposed as dc-dc power supplies for telecommunication applications which are different from WPT considerations, as herein, because the coupling coefficients in WPT applications are not always constant as in high-frequency isolation transformer. The uncertain and yet large leakage inductance in the loosely coupled transmitter and receiver coils in a WPT system could affect the soft-switching conditions in a phase-shift converter.

A partial solution to achieve soft-switching in phase-shift modulated power inverter is to use a quasi-resonant circuit as reported in [8]. Another suggestion of achieving soft switching in phase-shift modulated inverter is to use the modified inverter as reported in [9]. This is a rather complicated circuit when compared with a standard full-bridge inverter (with four switches with anti-parallel diodes). The extra components include 8 diodes and eight inductors. The authors of this reference claim that their circuit can achieve ZCS for a wide operating region (i.e., not full operating region). It is understood that this reference shows the quasi-resonant circuit cannot achieve soft switching for the full phase-shift angular range and hard switching occurs when the phase-shift angle exceeds 120 degrees. Industrial control integrated circuits for full ZVS of phase-shift inverter are available [10], but it requires coordinated control of the transmitter and receiver circuits.

Phase-shift control is commonly used in WPT systems as reflected in recent publications [11]-[18]. In [11], the effects of the dead time on the harmonics were examined. Phase-shift control was used for power and signal transfer in [12] and balancing currents in three-phase WPT systems in [13]. Phase-shift control is also used on the active rectifier on the receiver side of the WPT systems [14]. Phase shift control for soft switching for a wide operating range [15] and improving efficiency at light load [16] has been reported. Other WPT control schemes for parameter estimation and maximum efficiency tracking based on phase-shift inverters can be found in [17] and [18]. However, soft switching of phase-shift inverter for full operating range of phase-shift angle from 0° and 180° is difficult to achieve without communication and coordinated control between the transmitter (Tx) and receiver (Rx) circuits.

Hard-Switching of Known WPT Systems with Phase Shift Control

### A. Known SS-Compensated WPT Systems

The schematic diagram of a known SS-compensated WPT system is depicted in FIG. 1. The dc voltage V_{dc} is converted to a high-frequency ac voltage vₚ by a full-bridge inverter. The power is transmitted via the SS-compensated resonators. Lₚ and Lₛ are the self-inductance of the transmitting and receiving coils, respectively. M is the mutual inductance between the two coils. Rₚ and Rₛ are the equivalent series resistances (ESRs) of the resonators. The compensated capacitors Cₚ and Cₛ are designed in resonance with the self-inductances of the coils, such that the switching frequency and the resonant frequencies of the resonators are equal as

$$ω = \frac{1}{\sqrt{{L}_{p} {C}_{p}}} = \frac{1}{\sqrt{{L}_{S} {C}_{S}}} \qquad ( 1 )$$

where ω is the switching angular frequency of the inverter. For the resonators, according to the Kirchoff's circuit laws,

$${v}_{p 1} = ( j ω {L}_{p} + \frac{1}{j ω {C}_{p}} + {R}_{p} ) {i}_{p 1} - j ω M {i}_{s 1} \qquad ( 2.1 )$$

$$j ω {Mi}_{p 1} = ( j ω {L}_{S} + \frac{1}{j ω {C}_{S}} + {R}_{S} ) {i}_{s 1} + {v}_{s 1} \qquad ( 2.2 )$$

where iₚ₁ and iₛ₁ are the fundamental components of transmitter and receiver currents, and vₛ₁ is the fundamental component of the output voltage of the receiving resonator. By substituting (1) into (2.1) and (2.2) to eliminate Lₚ, Cₚ, Lₛ, and Cₛ,

$${v}_{p} = {R}_{p} {i}_{p} - j ω M {i}_{s} \qquad ( 3.1 )$$

$$j ω {Mi}_{p} = {R}_{s} {i}_{s} + {v}_{s} \qquad ( 3.2 )$$

According to (3.1), the receiver current iₛ₁ can be regulated by the fundamental component of the input voltage of the transmitting resonator (i.e., vₚ₁). The diode-bridge rectifier converts the receiver current to i_{rec}, the harmonics of which is filtered by the shunt capacitor C_{f}, such that a dc current I_{b} can charge the battery load. The charging current has a linear relationship with the amplitude of vₚ₁ (i.e., Vₚ₁). A larger Vₚ₁ results in a larger I_{b}. According to (3.2), vₛ₁ can be regulated by the transmitter current iₚ₁. The diode-bridge rectifier converts vₛ₁ to the charging voltage V_{b}, which has a linear relationship with the amplitude of iₚ₁ (i.e., Iₚ₁). A larger Iₚ results in a larger V_{b}. Therefore, the battery charging current and charging voltage can be regulated by the outputs of the primary-side inverter [19]. Here, both the battery charging current and output voltage are fed back into the phase shift controller to regulate the primary-side inverter. The schematic waveforms of the switching signals, i.e., S₁, S₂, S₃, and S₄, are plotted as shown in FIG. 2. The switching signals of each bridge leg are complementary and with the duty ratio of 0.5. A phase shift angle between the diagonal switching signals (i.e., α) is controlled by the primary-side controller. In FIG. 2, S₁ and S₂ are the leading signals with respect to S₄ and S₃. Thus, φ₁ and φ₂ can be considered as the leading bridge leg, while φ₃ and φ₄ can be considered as the lagging bridge leg. Based on the sketchy waveforms (without considering the deadtime such that switching signals are complementary for one bridge leg), Vₚ₁ and Iₚ₁ can be calculated based on V_{dc} and I_{dc} using Fourier analysis as:

$${V}_{p 1} = \frac{4}{π} cos ( \frac{α}{2} ) {V}_{dc} \qquad ( 4.1 )$$

$${I}_{p 1} = \frac{π}{2} sec ( \frac{α}{2} ) {I}_{dc} \qquad ( 4.2 )$$

The phase shift angle can be controlled for Vₚ and Iₚ regulations, such that the charging current and voltage can track the references during the constant current (CC) and constant voltage (CV) charging modes.

The control block diagram of the primary-side CC and CV charging control based on the phase shift control is depicted, as shown in FIG. 3. The battery output voltage V_{b} is compared to a threshold voltage Vᵥₐₗ to determine whether the WPT system operates in the CC or CV mode. Generally, the threshold voltage can be set as the as the reference voltage V_{bref}. If V_{b} is less than Vᵥₐₗ, the output is 0 such that the phase shift angle is derived by the current controller (i.e., Controller2). The charging current I_{b} is controlled to track the current reference I_{bref}. The WPT system operates in the CC charging mode. On the contrary, when V_{b} is greater than Vᵥₐₗ, the output is 1 such that the phase shift angle is derived by the voltage controller (i.e., Controller1). The charging voltage V_{b} is controlled to track the voltage reference V_{bref}. According to (3) and (4), both Controller1 and Controller2 can be linear controllers (e.g., proportional-integral (PI) controllers).

B. Operating Principles of the Known Full-Bridge Inverter with Phase Shift Control

Without losing generality, the equivalent impedance Zᵢₙ of the resonators and nonlinear loads can be modelled as a pure resistor when the harmonics of the resonator currents are small [20]. Thus, the transmitter current iₚ is in phase with the input voltage of the transmitting resonator vₚ. For WPT systems with light load conditions, the phase shift angle of the controller is generally large. Typical waveforms of iₚ and vₚ for a large phase shift angle are plotted, as shown in FIG. 2. During each full operating cycle of vₚ from t₁ to t₁₃, the waveform of vₚ comprises eight steady states (SS), i.e., SS1: t₁≤t<t₂, SS2: t₃≤t<t₄, SS3: tₛ≤t<t₆, SS4: t₆≤t<t₇, SS5: t₇≤t<t₈, SS6: t₉≤t<t₁₀, SS7: t₁₁≤t<t₁₂, and SS8: t₁₂≤t<t₁₃, and four transient states (TS), i.e., TS1: t₂≤t<t₃, TS2: t₄≤t<t₅, TS3: t₈≤t<t₉, and TS4: t₁₀≤t<t₁₁. The equivalent circuits of the full-bridge inverter with phase shift control during the twelve states are shown in FIG. 4. Here, the parasitic capacitances (i.e., C₁, C₂, C₃, and C₄) and diodes (i.e., D₁, D₂, D₃, and D₄) of the four power switches (i.e., φ₁, φ₂, φ₃, and φ₄) are assumed to be identical, although it will be appreciated that, in practice, there may be some minor discrepancies in parameters due to manufacturing tolerances.

Turning now to FIG. 4. the principles of operation of the power inverter in equivalent circuits of a known WPT system during one cycle will now be described. In the following discussion paragraph references—e.g. (a), (b), etc. —refer to the corresponding one of the individual circuit diagrams.
(a) At t₁, the switch φ₃ is turned off, while the switch φ₁ maintains the on-state and the switches φ₂ and φ₄ maintain off-state. The voltages across the parasitic capacitors C₂ and C₄ are V_{dc}, while the voltages across the parasitic capacitors C₁ and C₃ are 0. Due to the voltage cross the capacitor C₄ is V_{dc}, the diode D₃ is conducted. During the SS1 (t₁≤t<t₂), The transmitter current is continuous to be positive (i.e., iₚ>0).
(b) At t₂, the switch φ₄ is turned on, while the switch φ₁ maintains the on-state and the switches φ₂ and φ₃ maintain off-state. During the TS1 (t₂≤t<t₃), The parasitic capacitor C₃ is charged, while the parasitic capacitor C₄ is discharged. Due to the existence of voltage across the capacitor C₄ (i.e., V_{ds4}>0), the switch φ₄ is turned on with hard switching. During this period, the inverter current is still positive (i.e., iₚ>0).
(c) At t₃, the parasitic capacitor C₄ is fully discharged and the parasitic capacitor C₃ is fully charged. The switches φ₁ and φ₄ are on-state, while the switches φ₂ and φ₃ are off-state. During the SS2 (t₃≤t<t₄), the voltages across the capacitors C₁ and C₄ are 0, while the voltages across the capacitors C₂ and C₃ are V_{dc}. The transmitter current remains positive (i.e., iₚ>0).
(d) At t₄, the switch φ₁ is turned off, while the switch φ₄ maintains on-state and the switches φ₂ and φ₃ maintain off-state. The voltages across the parasitic capacitors C₃ and C₄ remains unchanged, while the parasitic capacitor C₁ is charged and the parasitic capacitor C₂ is discharged. During the TS2 (t₄≤t<tₛ), the capacitor C₁ is charged from 0 to V_{dc}, while the capacitor C₂ is discharged from V_{dc} to 0. The transmitter current remains positive (i.e., iₚ>0).
(e) At t₅, the parasitic capacitor C₂ is fully discharged and the parasitic capacitor C₁ is fully charged. Thus, the diode D₂ is conducted. During the SS3 (t₅≤t<t₆), the switch φ₄ remains on-state, while the switches φ₁, φ₂, and φ₃ are off-state. The transmitter current is positive (i.e., iₚ>0).
(f) At t₆, the switch φ₂ is turned on. The voltages across the parasitic capacitors C₁ and C₃ are V_{dc}, while the voltages across the parasitic capacitors C₂ and C₄ are 0. Therefore, the switch φ₂ is turned on with ZVS. During the SS4 (t₆≤t<t₇), the switches φ₂ and φ₄ are on-state, while the switches φ₁ and φ₃ are off-state. The transmitter current is positive (i.e., iₚ>0) during the first half period and negative (i.e., iₚ<0) during the second half period.
(g) At t₇, the switch φ₄ is turned off. The switch φ₂ remains on-state, while the switches φ₁ and φ₃ remain off-state. The voltage across the parasitic capacitor C₄ is 0 and the transmitter current is negative (i.e., iₚ<0). Hence, the diode D₄ is conducted during the SS5 (t₇≤t<t₈).
(h) At t₈, the switch φ₃ is turned on. The switch φ₂ remains on-state, while the switches φ₁ and φ₃ remain off-state. The voltages across the parasitic capacitors C₁ and C₃ are V_{dc}, while the voltages cross the parasitic capacitors C₂ and C₄ are 0. During the TS3 (t₈≤t< t₉), the capacitor C₃ is discharged, while the capacitor C4 is charged. Due to the existence of voltage across the capacitor C₃ (i.e., V_{ds3}>0), φ₃ is turned on with hard switching. The transmitter current is still negative (i.e., iₚ<0).
(i) At t₉, the capacitor C₃ is fully discharged and the capacitor C₄ is fully charged. Hence, the voltages across the parasitic capacitors C₁ and C₄ are V_{dc}, while the voltages across the parasitic capacitors C₂ and C₃ are 0 at this moment. During the SS6 (t₉≤t<t₁₀), the switches φ₂ and φ₃ are on-state, while the switches φ₁ and φ₄ are off-state. The transmitter current remains negative (i.e., iₚ<0).
(j) At t₁₀, the switch φ₂ is turned off, while the switch φ₃ maintains on-state and the switches φ₁ and φ₄ are still off-state. The voltages across the parasitic capacitors C₃ and C₄ remain unchanged, while the capacitor C₁ is discharged and the capacitor C₂ is charged. During the TS4 (t₁₀≤t<t₁₁), the capacitor C₁ is discharged from V_{dc} to 0, while the capacitor C₂ is charged from 0 to V_{dc}. The transmitter current is still negative (i.e., iₚ<0).
(k) At t₁₁, the parasitic capacitor C₂ is fully charged and the parasitic capacitor C₁ is fully discharged. Thus, the diode D₁ is conducted. During the SS7 (t₁₁≤t<t₁₂), the switch φ₃ is still on-state, while the switches φ₁, φ₂, and φ₄ are off-state. The transmitter current is still negative (i.e., iₚ<0).
(I) At t₁₂, the switch φ₁ is turned on. The voltages across the parasitic capacitors C₂ and C₄ are V_{dc}, while the voltages across the parasitic capacitors C₁ and C₃ are 0. Therefore, φ₁ is turned on with ZVS. During the SS8 (t₁₂≤t<t₁₃), the switches φ₁ and φ₃ are on-state, while the switches φ₂ and φ₄ are off-state. The transmitter current is negative (i.e., iₚ<0) during the first half period and positive (i.e., iₚ>0) during the second half period.

It can be seen from the analysis that ZVS can be naturally achieved by the leading bridge legs of the inverter with the known phase shift control, whereas hard switching occurs on the switches of the lagging bridge leg during the transient periods TS1 (t₂≤t<φ₃) and TS3 (t₈≤t<t₉). As a result, the EMI emission of the full-bridge inverter could be high, especially the conducted EMI from 150 kHz to 30 MHz, which may violate the EMC standard EN55022.

### SUMMARY

Aspects of the invention are as set out in the independent claims. Some optional features are defined in the dependent claims.

Implementation of the techniques disclosed herein may provide significant technical advantages. For instance, as will be demonstrated below, zero-voltage switching (ZVS) can be achieved to enable airfares-shift modulator power inverter to enable all power switches to be soft-switched for all operating regions, including in the lagging bridge leg. Consequently, the power inverter can be operated with reduced switching power loss and attenuated electromagnetic interference. Thus, the converter can operate with a higher frequency while the EMI is still within the required boundaries.

In one arrangement, an “augmented passive circuit” comprises two diodes, two capacitors, and one inductor for a full-bridge inverter with known phase-shift control in wireless power transfer (WPT) systems. The operation may achieve soft switching and reduce the EMI radiation for a wide range of phase shift angles, up to the full range of phase shift angle from 0° to 180°. Such full-range ZVS operation may attained without any communication and/or coordinated control with the receiver circuit. Both simulation and experimental results show that ZVS can be achieved by the augmented circuit for a WPT system in both constant current (CC) and constant voltage (CV) control modes. Practical EMI tests demonstrate that the augmented circuit can mitigate the conducted EMI of the full-bridge inverter to meet the standard EN55022 with a full range of phase-shift angle from 0° to 180°. The proposed augmented circuit so adds soft-switching feature to a phase-shift inverter regardless of the types of resonant circuits in the WPT systems, therefore making it flexible for the inverter to drive different type of WPT systems in existing wireless charging standards.

Existing methods require more circuit components and cannot achieve soft switching for the entire operating range of the phase-shift-modulated inverter. The techniques disclosed herein have at least the following advantages:
fewer circuit components than existing methods, with reduced cost.
There is no active power switch and therefore does not need extra gate drive circuit for power switch.
The augmented passive circuit can be added to existing phase-shift modulated power inverter.
The augmented passive circuit enables a phase-shift modulated power inverter to achieve soft switching (through zero-voltage switching) for the entire operating range.

An augmented passive circuit (with connections shown in FIG. 5) comprises two diodes, two capacitors and one inductor for achieving soft switching in all the power switches in a power inverter under phase-shift modulation control.

The augmented passive circuit can be added to a power inverter to achieve soft switching under either fixed-frequency or variable-frequency operations of power inverter.

The augmented passive circuit can reduce the switching power stress and power losses to improve the lifetime and conversion efficiency of power inverters.

The augmented passive circuit can be used to modify existing designs of wireless power transfer systems compliant with the standards of the Wireless Power Consortium and Society of Automotive Engineers without changing the control algorithms.

A design method for the augmented passive circuit is also herein disclosed, based on the equations (25) to (27) set forth below.

Power inverters are widely used for a large range of modern commercial applications such as switched mode power supplies, battery chargers and wireless charging systems with markets in tens of billions of US dollars. The techniques can be applied to a wide variety of applications, but are particularly useful in wireless charging, including with mobile phones and mobile robotics such as robotic lawn mowers and robotic vacuum cleaners

### BRIEF DESCRIPTION OF THE DRAWINGS

The invention will now be described, by way of example only, and with reference to the accompanying drawings in which:

FIG. 1 is a schematic diagram of a typical SS-compensated WPT system;

FIG. 2 is a voltage- and current-time diagram illustrating schematic waveforms of the switching signals of a known power inverter for a WPT system;

FIG. 3 is a control block diagram of known phase shift control for WPT systems in achieving CC and CV charging as described in [19];

FIG. 4 is a series of equivalent circuit diagrams illustrating a cycle of operation of a power inverter of a known WPT system;

FIG. 5 is a circuit diagram of a power inverter implementing an exemplary passive augmented circuit in accordance with the techniques described herein;

FIG. 6 is a voltage- and current-time diagram illustrating schematic waveforms of the switching signals of a power inverter for a WPT system implementing an exemplary passive augmented circuit in accordance with the techniques described herein;

FIG. 7 is a series of equivalent circuit diagrams illustrating a cycle of operation of a power inverter implementing an augmented passive circuit in accordance with the techniques described herein;

FIG. 8 illustrates waveforms of I_{b}, I_{bref}, iₚ, vₚ, and switching signals of the WPT system (a) without the augmented circuit, and (b) with the augmented circuit in a simulation case 1;

FIG. 9 illustrates waveforms of drain currents and drain-to-source voltages of the four switches of the WPT system (a) without the augmented circuit and (b) with the augmented circuit in the simulation case 1;

FIG. 10 illustrates V_{ds}-I_{d} curves of the four switches of the WPT system without and with the augmented circuit in case 1;

FIG. 11 illustrates waveforms of V_{b}, V_{bref}, iₚ, vₚ, and switching signals of the WPT system (a) without the augmented circuit, and (b) with the augmented circuit in case 2;

FIG. 12 illustrates waveforms of drain currents and drain-to-source voltages of the four switches of the WPT system (a) without the augmented circuit and (b) with the augmented circuit in case 2;

FIG. 13 illustrates V_{ds}-I_{d} curves of the four switches of the WPT system without and with the augmented circuit in case 2;

FIG. 14 illustrates waveforms of v_{ds3}, i_{d3}, iₚ, and vₚ of WPT systems (a) without augmented circuit and (b) with augmented circuit for the current control;

FIG. 15 illustrates conducted EMI from full-bridge inverter (a) without augmented circuit and (b) with augmented circuit for the current control;

FIG. 16 illustrates magnified waveforms of v_{ds3} and i_{d3} of WPT systems (a) without augmented circuit and (b) with augmented circuit for the voltage control;

FIG. 17 illustrates conducted EMI from full-bridge inverter (a) without augmented circuit and (b) with augmented circuit for the voltage control;

FIG. 18 illustrates conducted EMI from full-bridge inverter without and with the augmented circuit when the phase shift angle is controlled at 120°, 90°, 60°, 30°, and 0°;

FIG. 19 illustrates background EMIs of the test chamber; and

FIG. 20 illustrates waveforms of v_{ds3}, i_{d3}, iₚ, and vₚ of the WPT system with and without the augmented circuit for different phase shift angles.

### DETAILED DESCRIPTION

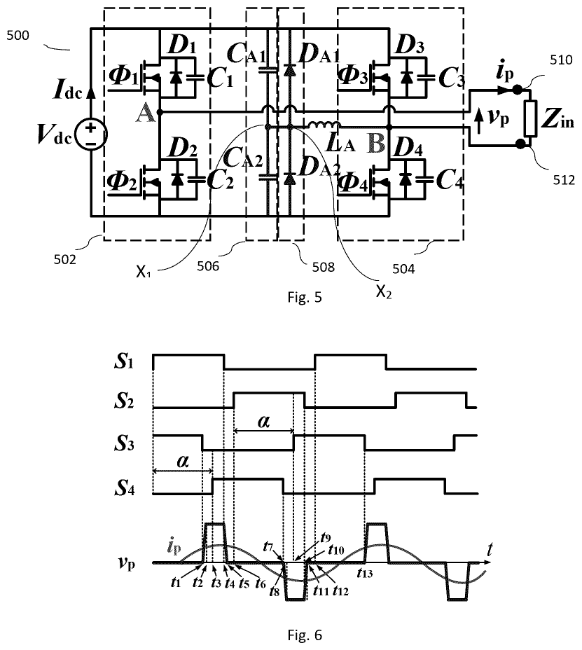

The circuit diagram of a power inverter implementing an exemplary augmented passive circuit in accordance with the techniques herein disclosed is depicted as shown in FIG. 5. In this, the proposed augmented passive circuit comprises an inductor L_{A}, two diodes D_{A1} and D_{A2}, and two parallel-connected capacitors C_{A1} and C_{A2}. The circuit is termed an “augmented passive circuit” in as much as it is “passive” by not requiring any active switching components. The circuit “augments” a known phase-shift modulated full-bridge power inverter. In the example of FIG. 5, power inverter 500 is manufactured complete with the augmented passive circuit, however the augmented passive circuit may also be fitted (e.g. retro-fitted) to existing power inverters of known design.

As shown in FIG. 5, the phase-shift modulated full-bridge power inverter 500 comprises a leading bridge leg 502 comprising: a first power switch φ₁, the first power switch having a first power switch parasitic capacitance C₁; and a second power switch φ₂, the second power switch having a second power switch parasitic capacitance C₂. The first and second power switches φ₁ and φ₂ are connected in series with one another at leading bridge leg connection point A of leading bridge leg 502. Power inverter 500 further comprises a lagging bridge leg 504 comprising: a third power switch φ₃, the third power switch having a third power switch parasitic capacitance C₃; and a fourth power switch φ₄, the fourth power switch having a fourth power switch parasitic capacitance C₄. The third and fourth power switches φ₃ and φ₄ are connected in series with one another at lagging bridge leg connection point B of lagging bridge leg 504.

Exemplary types of power switches include, as noted above, MOSFETs and IGBTs.

In the example of FIG. 5, power inverter 500 comprises a capacitor circuit branch 506 comprising first augmented circuit capacitor C_{A1} and second augmented circuit capacitor C_{A2} connected in series with one another at capacitor branch connection point X₁. Capacitor circuit branch 506 is connected in parallel with the leading bridge leg 502 and lagging bridge leg 504. Continuing in this example, the power inverter 500 comprises a diode circuit branch 508 comprising first augmented circuit diode D_{A1} and second augmented circuit diode D_{A2} connected in series with one another at diode branch connection point X₂. Diode circuit branch 508 is connected in parallel with the leading bridge leg 502 and lagging bridge leg 504. In this example, capacitor circuit branch connection point X₁ and diode circuit branch connection point X₂ are electrically connected with one another.

Leading bridge leg connection point A is connected to a first output terminal 510 of the power inverter for connection to a load Z, in this case a wireless power transfer charging load. Lagging bridge leg connection point B is connected to a second output terminal 512 of the power inverter for connection to the load Z. In operation, a load voltage Vₚ is developed across the load Z and a load current iₚ flows through load Z.

Power inverter 500 further comprises augmented circuit inductor L_{A} connected on a first side (at a first inductor terminal) to the capacitor branch connection point X₁ and the diode branch connection point X₂. Inductor L_{A} is also connected on a second side (at the second inductor terminal) to one of the first and second output terminals 510, 512.

Together, augmented circuit inductor L_{A}, capacitor circuit branch 506 and diode circuit branch 508 together form an augmented passive circuit which operate to reduce or even remove discontinuous current which occurs, particularly when the phase-shift angle is large. In turn, this achieves soft-switching and reduces (or even removes) power loss and electromagnetic interference (EMI) arising from the switching of power switches.

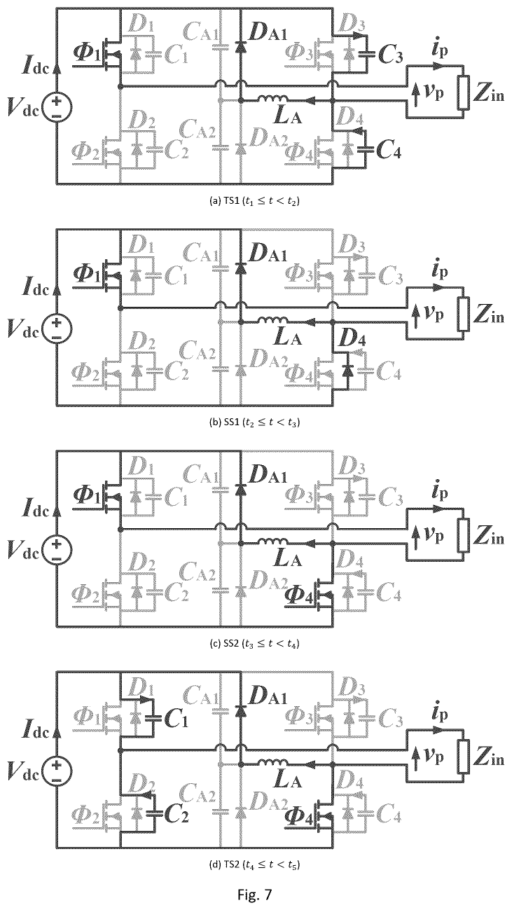

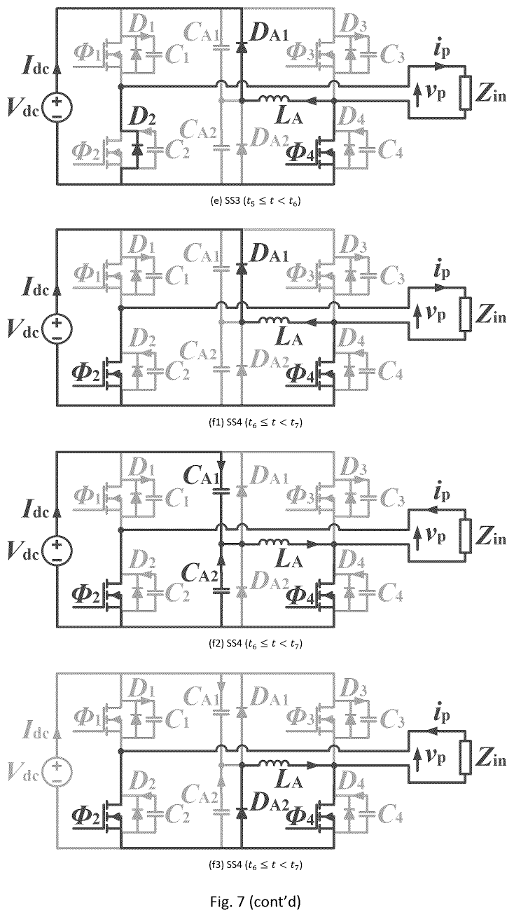

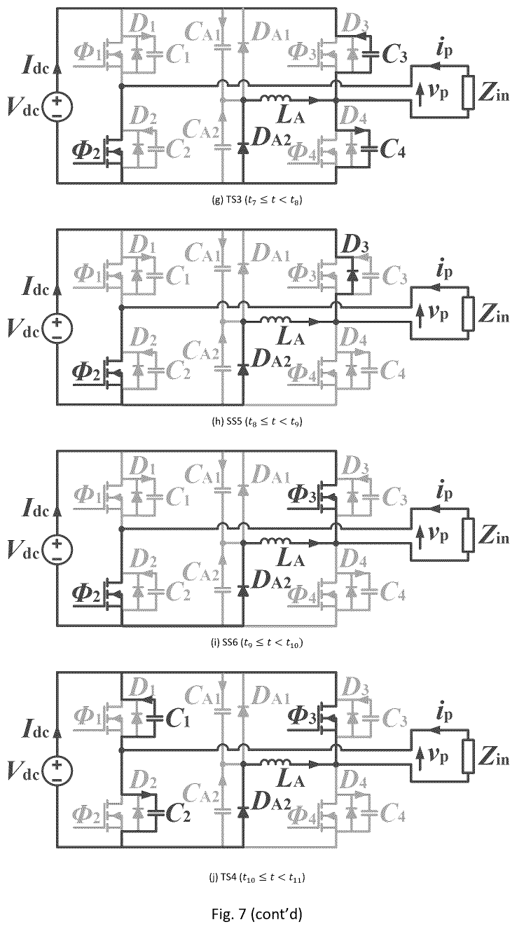

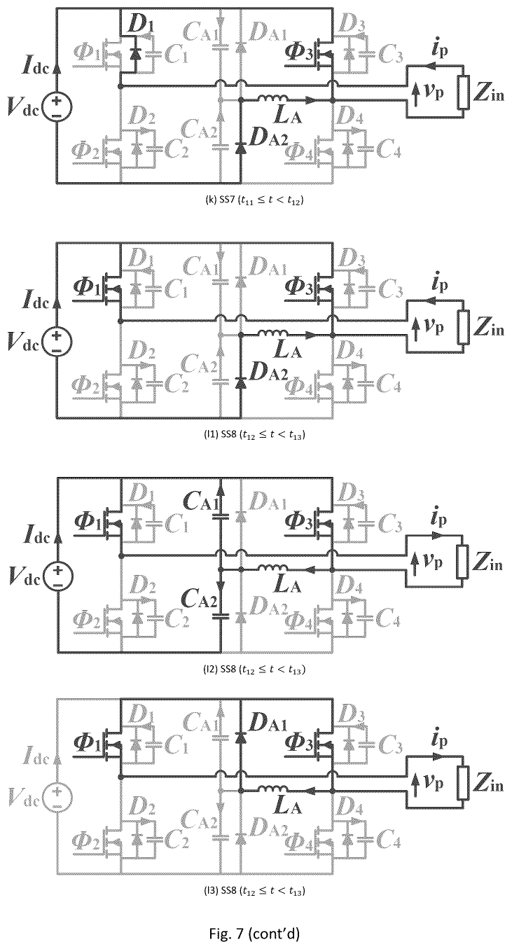

The schematic waveforms of the switching signals, iₚ and vₚ of the WPT system with the augmented circuit are plotted as shown in FIG. 6. During each cycle (i.e., from t₁ to t₁₃), the waveform of vₚ comprises eight steady states (SS), i.e., SS1: t₂≤t<t₃, SS2: t₃≤t<t₄, SS3: t₅≤t<t₆, SS4: t₆≤t<t₇, SS5: t₈≤t<t₉, SS6: t₉≤t<t₁₀, SS7: t₁₁≤t<t₁₂, and SS8: t₁₂≤t<t₁₃, and four transient states (TS), i.e., TS1: t₁≤t<t₂, TS2: t₄≤t<t₅, TS3: t₇≤t<t₈, TS4: t₁₀≤t<t₁₁. The equivalent circuits during one cycle of operation are depicted, as shown in FIG. 7. In the following discussion paragraph references—e.g. (a), (b), etc.—refer to the corresponding one of the individual circuit diagrams.
(a) At t₁, the switch φ₃ is turned off, while the switch φ₁ is kept on-state and the switches φ₂ and φ₄ are kept off-state. The transmitter current is positive (i.e., iₚ>0). The voltages across the parasitic capacitors C₂ and C₄ are V_{dc}, while the voltages across the parasitic capacitors C₁ and C₃ are 0. During the TS1 (t₁≤t<t₂), the capacitor C₃ is charged and the capacitor C₄ is discharged. The augmented inductor L_{A} and the parasitic capacitors C₃ and C₄ can form an LC resonator, such that the energy stored in the parasitic capacitor C₄ can be released before the switch φ₄ is turned on.

So, it will be appreciated that FIGS. 5 and 6 and associated text illustrate and describe a phase-shift modulated full-bridge power inverter 500 configured for use in a wireless power transfer system, the power inverter 500 comprising: a leading bridge leg 502 comprising: a first power switch φ₁, the first power switch φ₁ having a first power switch parasitic capacitance C₁; and a second power switch φ₂, the second power switch φ₂ having a second power switch parasitic capacitance C₂; a lagging bridge leg 504 comprising: a third power switch φ₃, the third power φ₃ switch having a third power switch parasitic capacitance C₃; and a fourth power switch φ₄, the fourth power switch φ₄ having a fourth power switch parasitic capacitance C₄; wherein the power inverter 500 is configured for each of the power switches to be switched on and off in a switching cycle; and wherein the power inverter further comprises: an augmented passive circuit comprising an inductor L_{A}, wherein the power inverter 500 is configured for the inductor L_{A} to combine with the third power switch parasitic capacitance C₃ and the fourth power switch capacitance C₄ to form a resonator when a first one of the third and fourth power switches φ₃, φ₄ (in this step (a), this is the third power switch φ₃) is switched off and a second one of the third and fourth power switches φ₃, φ₄ (in this step (a), this is the fourth power switch φ₄) is in a switched off state, and for energy stored in the parasitic capacitance of the second one of the third and fourth power switches (in this step (a), this is C₄ of φ₄) to be discharged before the second one of the third and fourth power switches (in this step (a), this is φ₄) is switched on.

A corresponding method is also described.

The significance of this discharge of the energy stored in the parasitic capacitor C₄ will become evident from step (c) below. The discharge/release of the parasitic capacitor C₄ energy can be full or partial discharge.

According to the resonant circuit, the current flowing through the augmented inductor, and the voltages across the capacitors C₃ and C₄ can be expressed as

$${i}_{L A} ( t ) = \frac{{V}_{d c}}{\sqrt{\frac{{L}_{A}}{2 {C}_{A}}}} cos [ \frac{1}{\sqrt{2 {L}_{A} {C}_{Q}}} ( t - {t}_{1} ) ] \qquad ( 5 )$$

$${v}_{C 3} ( t ) = {V}_{d c} \sqrt{\frac{{C}_{A}}{{C}_{Q}}} sin [ \frac{1}{\sqrt{2 {L}_{A} {C}_{Q}}} ( t - {t}_{1} ) ] \qquad ( 6 )$$

$${v}_{C 4} ( t ) = {V}_{d c} - {V}_{d c} \sqrt{\frac{{C}_{A}}{{C}_{Q}}} sin [ \frac{1}{\sqrt{2 {L}_{A} {C}_{Q}}} ( t - {t}_{1} ) ] \qquad ( 7 )$$

Here, the transmitter current is mainly determined by the resonators of the WPT system, which will not affect the amplitudes and frequency of the augmented inductor current and the voltages across the capacitors. Besides, the amplitude of the augmented inductor current is determined by the previous state of the system circuit due to its continuity. The TS1 period can be calculated based on (6) or (7) as

$$Δ {t}_{12} = \sqrt{2 {L}_{A} {C}_{Q}} {sin}^{- 1} ( \sqrt{\frac{{C}_{Q}}{{C}_{A}}} ) \qquad ( 8 )$$

(b) At t₂, the parasitic capacitor C₃ is fully charged and the parasitic capacitor C₄ is fully discharged. The switch φ₁ is turned on, while the switches φ₂, φ₃, and φ₄ are turned off. The augmented inductor current can be calculated by substituting (8) into (5), as

$${i}_{L A} ( {t}_{2} ) = {V}_{d c} \sqrt{\frac{2 ( {C}_{A} - {C}_{Q} )}{{L}_{A}}} \qquad ( 9 )$$

During the SS1 (t₂≤t<t₃), both the transmitter current and augmented inductor current are positive (i.e., iₚ>0 and i_{LA}>0).
(c) At t₃, the switch φ₄ is turned on. The switch φ₁ is kept on-state and the switches φ₂ and φ₃ are kept off-state. The transmitter current is still positive (i.e., iₚ>0). During the SS2 (t₃≤t<t₄), the augmented inductor current is decreased when the DC source is connected, as

$${i}_{L A} ( t ) = {V}_{d c} \sqrt{\frac{2 ( {C}_{A} - {C}_{Q} )}{{L}_{A}}} - \frac{{V}_{d c}}{{L}_{A}} ( t - {t}_{3} ) \qquad ( 10 )$$

Since the voltage across the capacitor C₄ is zero, φ₄ is turned on with ZVS. Thus, the incorporation of the augmented passive circuit into power inverter 500 is significant in reducing or even removing the undesirable power loss and EMI from the power switch present in the prior art.
(d) At t₄, the switch φ₁ is turned off. The switch φ4 is kept on-state and the switches φ₂ and φ₃ are kept off-state. The voltages across the parasitic capacitors C₁ and C₄ are 0, while the voltages across the parasitic capacitors C₂ and C₃ are V_{dc}. The transmitter current is still positive (i.e., iₚ>0). During the TS2 (t₄≤t<t₅), the augmented inductor current is further decreased based on (10). By assuming the transmitter current to be Iₚ sin(ωt+θ), the voltages across the parasitic capacitors C₁ and C₂ can be expressed as

$${v}_{C 1} ( t ) = - \frac{{I}_{p}}{2 ω {C}_{Q}} cos ( ω t + θ ) \qquad ( 11 )$$

$${v}_{C 2} ( t ) = {V}_{d c} + \frac{{I}_{p}}{2 ω {C}_{Q}} cos ( ω t + θ ) \qquad ( 12 )$$

$$Then , the TS 2 period can be calculated by$$

$$Δ {t}_{45} = \frac{{cos}^{- 1} ( - \frac{2 {ωC}_{Q} {V}_{dc}}{{I}_{P}} ) - \frac{π}{2}}{ω} \qquad ( 13 )$$

(e) At tₛ, since C₂ is fully discharged, the diode D₂ is conducted. During the SS3 (t₅≤t<t₆), the transmitter current is still positive (i.e., iₚ>0) and the augmented inductor current is further decreased based on (10).
(f) At t₆, the switch φ₂ is turned on, while the switch φ₄ is kept on-state and the switches φ₁ and φ₃ are kept off-state. Since the voltage across the capacitor C₂ is zero, φ₂ is turned on with ZVS. During the SS4 (t₆≤t<t₇), the transmitter current is positive during the first half period, while it is negative during the second half period. The augmented inductor current is further decreased based on (10). When the inductor current is reduced to 0, the diode D_{A1} is blocked. The inductor current becomes negative, which is the sum of the augmented capacitor currents (i.e., I_{LA}=I_{CA1}+I_{CA2}), as shown in FIG. 7(f2). When the augmented capacitor C_{A1} is fully charged and the augmented capacitor C_{A2} is fully discharged, the diode D_{A2} is conducted and the augment inductor is kept unchanged at the minimum value as

$${i}_{L A} ( t ) = - \frac{{V}_{dc}}{\sqrt{\frac{{L}_{A}}{2 {C}_{A}}}} \qquad ( 14 )$$

Thus, summarising at this juncture, the augmented passive circuit further comprises a diode circuit branch 508, the diode circuit branch comprising a first diode D_{A1} and a second diode D_{A2} connected in series with one another, the diode circuit branch 508 being connected in parallel to the leading bridge leg 502 and the lagging bridge leg 504, the power inverter 500 being configured for, when a first one of the first and second power switches (in this step (f), this is φ₂) is switched on and a second one of the first and second power switches (in this step (f), this is φ₁) is in a switched off state, the first one of the third and fourth power switches (in this step (f), this is φ₃) is in a switched off state and a second one of the third and fourth power switches (in this step (f), this is φ₄) is in a switched on state, for a first one of the first and second diodes (in this step (f), this is D_{A1}) to be in a conductive state and a second one of the first and second diodes (in this step (f), this is D_{A2}) to be in a non-conductive state; and wherein the power inverter 500 is configured for current in the inductor L_{A} to become zero, and for the first one of the first and second diodes (in this step (f), this is D_{A1}) to be switched to a non-conductive state.

Further summarising, the augmented passive circuit further comprises a capacitor circuit branch 506, the capacitor circuit branch 506 comprising a first capacitor CA1 and a second capacitor C_{A2} connected in series with one another, the capacitor circuit branch 506 being connected in parallel to the leading bridge leg 502 and the lagging bridge leg 504, the power inverter 500 being configured for a magnitude of the current in the inductor L_{A} to increase (in this step (f), the inductor current becomes negative after having been zero), for a first one of the first capacitor and the second capacitor (in this step (f), this is C_{A1}) to be fully charged and for a second one of the first capacitor and the second capacitor to be fully discharged (in this step (f), this is C_{A2}), and for the second one of the first and second diodes (in this step (f), this is D_{A2}) to be switched to a conductive state.
(g) At t₇, the switch φ₄ is turned off, while the switch φ₂ is kept on-state and the switches φ₁ and φ₃ are kept off-state. The transmitter current is negative (i.e., iₚ<0). The voltage across the parasitic capacitors C₁ and C₃ are V_{dc}, while the voltages across the parasitic capacitors C₂ and C₄ are 0. During the TS3 (t₇≤t<t₈), the capacitor C₃ is discharged and the capacitor C₄ is charged. The augmented inductor L_{A} and the parasitic capacitors C₃ and C₄ can form an LC resonator, such that the energy stored in the parasitic capacitor C₃ can be released before the switch φ₃ is turned on. The current flowing through the augmented inductor, and the voltages across the capacitors C₃ and C₄ can be expressed as

$${i}_{L A} ( t ) = - \frac{{V}_{dc}}{\sqrt{\frac{{L}_{A}}{2 {C}_{A}}}} cos [ \frac{1}{\sqrt{2 {L}_{A} {C}_{Q}}} ( t - {t}_{7} ) ] \qquad ( 15 )$$

$${v}_{C 3} ( t ) = {V}_{dc} - {V}_{dc} \sqrt{\frac{{C}_{A}}{{C}_{Q}}} sin [ \frac{1}{\sqrt{2 {L}_{A} {C}_{Q}}} ( t - {t}_{7} ) ] \qquad ( 16 )$$

$${v}_{C 4} ( t ) = {V}_{dc} \sqrt{\frac{{C}_{A}}{{C}_{Q}}} sin [ \frac{1}{\sqrt{2 {L}_{A} {C}_{Q}}} ( t - {t}_{7} ) ] \qquad ( 17 )$$

The TS3 period can be calculated based on (16) or (17) as

$$Δ {t}_{78} = \sqrt{2 {L}_{A} {C}_{Q}} s i {n}^{- 1} ( \sqrt{\frac{{C}_{Q}}{{C}_{A}}} ) \qquad ( 18 )$$

Thus, in this step the augmented passive circuit again operates where the power inverter 500 is configured for the inductor L_{A} to combine with the third power switch parasitic capacitance C₃ and the fourth power switch capacitance C₄ to form a resonator, but the switching arrangement is the reverse of that described above in step (a), viz: when a first one of the third and fourth power switches φ₃, φ₄ (in this step (g), this is now the fourth power switch φ₄) is switched off and a second one of the third and fourth power switches φ₃, φ₄ (now, in this step (g), the third power switch φ₃) is in a switched off state, and for energy stored in the parasitic capacitance of the second one of the third and fourth power switches (in this step (g), this is C₃ of φ₃) to be discharged before the second one of the third and fourth power switches (in this step (g), this is φ₃) is switched on.
(h) At t₈, the parasitic capacitor C₄ is fully charged and the parasitic capacitor C₃ is fully discharged. The switch φ₂ is on-state, while the switches φ₁, φ₃, and φ₄ are off-state. The augmented inductor current can be calculated by substituting (18) into (15), as

$${i}_{L A} ( {t}_{8} ) = - {V}_{d c} \sqrt{\frac{2 ( {C}_{A} - {C}_{Q} )}{{L}_{A}}} \qquad ( 19 )$$

During the SS5 (t₈≤t<t₉), both the transmitter current and augmented inductor current are negative (i.e., iₚ<0 and i_{LA}<0).
(i) At t₉, the switch φ₃ is turned on. The switch φ₂ is kept on-state and the switches φ₁ and φ₄ are kept off-state. The transmitter current is still negative (i.e., iₚ<0). During the SS6 (t₉≤t<t₁₀), the augmented inductor current is increased when the DC source is connected, as

$${i}_{L A} ( t ) = - {V}_{d c} \sqrt{\frac{2 ( {C}_{A} - {C}_{Q} )}{{L}_{A}}} + \frac{{V}_{d c}}{{L}_{A}} ( t - {t}_{9} ) \qquad ( 20 )$$

Since the voltage across the capacitor C₃ is zero, φ₃ is turned on with ZVS.
(j) At t₁₀, the switch φ₂ is turned off. The switch φ₃ is kept on-state and the switches φ₁ and φ₄ are kept off-state. The voltages across the parasitic capacitors C₂ and C₃ are 0, while the voltages across the parasitic capacitors C₁ and C₄ are V_{dc}. The transmitter current is still negative (i.e., iₚ<0). During the TS4 (t₁₀≤t<t₁₁), the augmented inductor current is further increased based on (20). By assuming the transmitter current is Iₚ sin(ωt+θ), the voltages across the capacitors C₁ and C₂ can be expressed as

$${v}_{C 1} ( t ) = \frac{{I}_{p}}{2 ω {C}_{Q}} cos ( ω t + θ ) \qquad ( 21 )$$

$${v}_{C 2} ( t ) = {V}_{d c} - \frac{{I}_{p}}{2 ω {C}_{Q}} cos ( ω t + θ ) \qquad ( 22 )$$

Then, the TS4 period can be calculated as

$$Δ {t}_{1011} = \frac{\frac{π}{2} - {cos}^{- 1} ( \frac{2 {ωC}_{Q} {V}_{dc}}{{I}_{p}} )}{ω} \qquad ( 23 )$$

(k) At t₁₁, since C₁ is fully discharged, the diode D₁ is conducted. During the SS7 (t₁₁≤t<t₁₂), the transmitter current is still negative and the augmented inductor current is further increased based on (20).
(l) At t₁₂, the switch φ₁ is turned on, while the switch φ₃ is kept on-state and the switches φ₂ and φ₄ are kept off-state. Since the voltage across the capacitor C₁ is zero, φ₁ is turned on with ZVS. During the SS8 (t₁₂≤t<t₁₃), the transmitter current is negative during the first half period, while it is positive during the second half period. The augmented inductor current is further increased based on (20). When the inductor current is increased to 0, the diode D_{A2} is blocked. The inductor current becomes positive, which is the sum of the augmented capacitor currents (i.e., I_{LA}=I_{CA1}+I_{CA2}), as shown in FIG. 7(I2). When the augmented capacitor C_{A1} is fully discharged and the augmented capacitor C_{A2} is fully charged, the diode D_{A1} is conducted and the augment inductor is kept unchanged at the maximum value as

$${i}_{L A} ( t ) = \frac{{V}_{dc}}{\sqrt{\frac{{L}_{A}}{2 {C}_{A}}}} \qquad ( 24 )$$

Thus, summarising again at this juncture, it will be seen once more that the power inverter 500 is configured for, a first one of the first and second power switches (in this step (I), this is φ₁) is switched on and a second one of the first and second power switches (in this step (I), this is φ₂) is in a switched off state, the first one of the third and fourth power switches (in this step (I), this is φ₄) is in a switched off state and a second one of the third and fourth power switches (in this step (I), this is φ₃) is in a switched on state, for a first one of the first and second diodes (in this step (I), this is D_{A2}) to be in a conductive state and a second one of the first and second diodes (in this step (I), this is D_{A1}) to be in a non-conductive state; and wherein the power inverter 500 is configured for current in the inductor L_{A} to become zero, and for the first one of the first and second diodes (in this step (I), this is D_{A2}) to be switched to a non-conductive state.

Further summarising, it will be seen once more that the power inverter 500 is configured for a magnitude of the current in the inductor L_{A} to increase (in this step (I), the inductor current becomes positive after having been zero), for a first one of the first capacitor and the second capacitor (in this step (I), this is C_{A2}) to be fully charged and for a second one of the first capacitor and the second capacitor to be fully discharged (in this step (I), this is C_{A1}), and for the second one of the first and second diodes (in this step (I), this is D_{A1}) to be switched to a conductive state.

Obviously, the WPT system with the known phase shift control can implement ZVS for both bridge legs with the integration of the augmented circuit. As a result, the EMI emission, especially the conducted EMI can be reduced.

Assume that the augmented inductor current takes about

$$\frac{1}{N}$$

switching cycle to increase from 0 to the maximum value (i.e., Iₘₐₓ), such as

$$\frac{π}{2} \sqrt{2 {L}_{A} {C}_{A}} = \frac{{T}_{s}}{N} \qquad ( 25 )$$

Then, the parameters of the augmented inductor and capacitors can be calculated based on (24) and (25) as

$${L}_{A} = \frac{2 {V}_{dc} {T}_{s}}{{I}_{max} N π} \qquad ( 26 )$$

$${C}_{A} = \frac{{I}_{max} {T}_{s}}{{V}_{dc} N π} \qquad ( 27 )$$

Therefore, a passive augmented circuit is disclosed that can turn a phase-shift power inverter into a fully soft-switched power inverter for the entire operating range (i.e. phase-shift angle from 0° to 180°. The proposed passive circuit has the following advantageous features:
Independent of the compensation topologies of the transmitter (Tx) and receiver (Rx) circuits. For wireless power transfer systems, the leakage inductances of the transmitting and receiving coils require capacitive compensation. The compensation networks can be various types, i.e., series-series (capacitors in series for both Tx and Rx coils), series-parallel (the capacitor in series with Tx coil and the capacitor in parallel with Rx coil), LCC-LCC, and so on;
No requirement for the regulations of firing angles of the power switches or switching frequencies based on in-band or out-of-band communication between the Tx and Rx circuits;
It may be implemented for full load operating conductions including light- and no-load conditions;
It may be implemented for constant frequency operation of the inverter output voltage.

The proposed circuit has been tested for the full range of phase-shift angle from 0° to 180°. Practical measurements of the circuit waveforms and electromagnetic radiation are included to confirm its feasibility to achieve soft switching in the full operating range.

As noted above, the augmented passive circuit can be fitted (for example, retrofitted) to a phase-shift modulated full-bridge power inverter configured for use in a wireless power transfer system. Thus, a method of fitting (retrofitting) comprises connecting a capacitor circuit branch 506 in parallel to the leading bridge leg 502 and the lagging bridge leg 504, the capacitor circuit branch comprising a first capacitor C_{A1} and a second capacitor C_{A2} connected in series with one another at a capacitor branch connection point X₁; connecting a diode circuit branch 508 in parallel to the leading bridge leg 502 and the lagging bridge leg 504, the diode circuit branch 508 comprising a first diode D_{A1} and a second diode D_{A1} connected in series with one another at a diode branch connection point X₂; and connecting an inductor L_{A} at a first inductor terminal to the capacitor branch connection point X₁ and the diode branch connection point X₂ and connecting the inductor L_{A} at a second inductor terminal to one of the first and second output terminals 510, 512.

Components for the augmented passive circuit may be provided in the form of a kit of parts for fitting to a phase-shift modulated full-bridge power inverter configured for use any wireless power transfer system. Thus, a kit of augmented passive circuit parts for fitting to a phase-shift modulated full-bridge power inverter 500 configured for use in a wireless power transfer system, comprises: a first capacitor C_{A1} and a second capacitor C_{A2} to be connected in series with one another at a capacitor branch connection point X₁ in a capacitor circuit branch 506, the capacitor circuit branch 506 to be connected in parallel to a leading bridge leg 502 and a lagging bridge leg 504 of the power inverter; a first diode D_{A1} and a second diode D_{A2} to be connected in series with one another at a diode branch connection point X₂ in a diode circuit branch 508, the diode circuit branch 508 to be connected in parallel to the leading bridge leg 502 and the lagging bridge leg 504; and an inductor L_{A} to be connected at a first inductor terminal to the capacitor branch connection point X₁ and the diode branch connection point X₂ and to be connected at a second inductor terminal to one of power inverter first and second output terminals 510, 512.

### Simulation Results

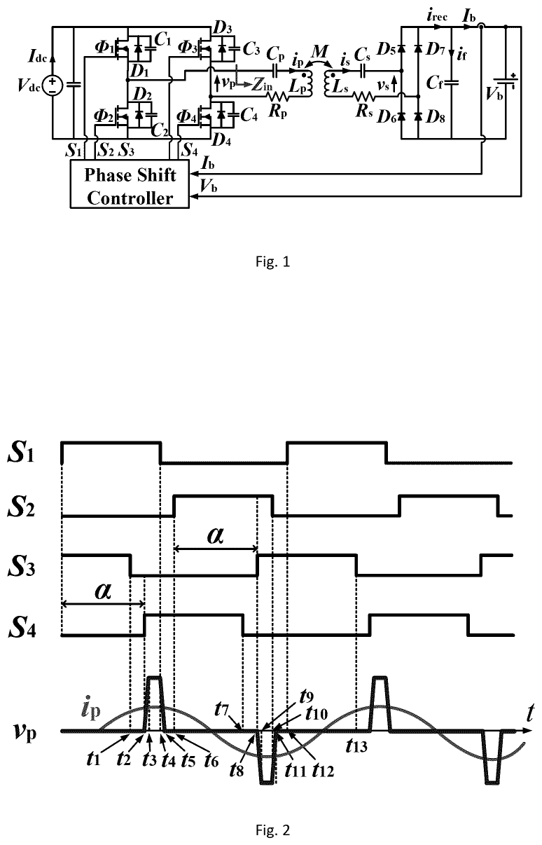

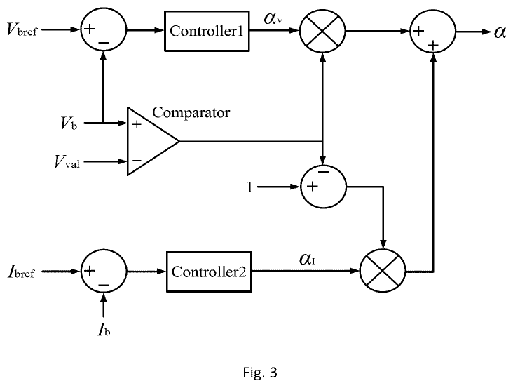

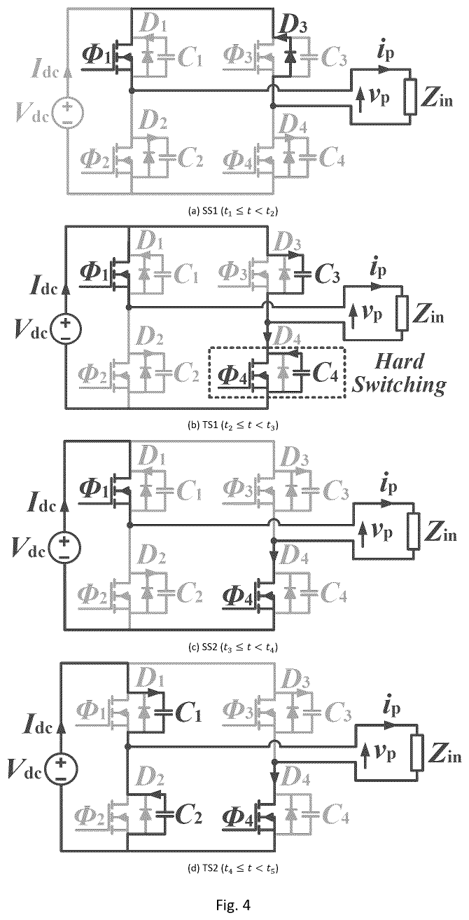

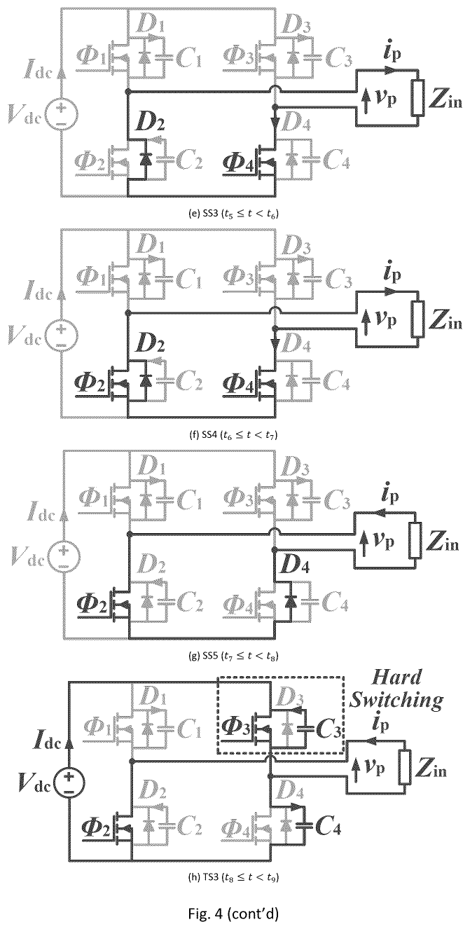

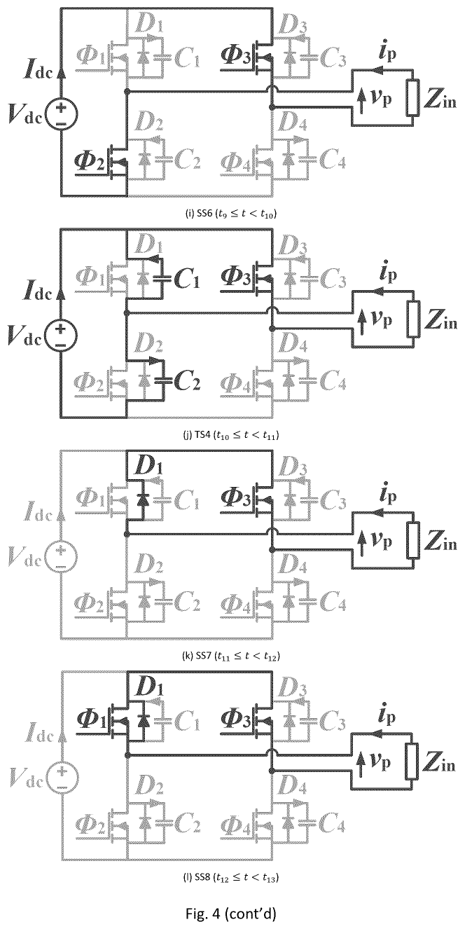

Simulations are carried out on a WPT system (schematic diagram as shown in FIG. 1) with the parameters given in Table 1 using Psim10.0. The battery load is modelled as a pure resistive load R_{L} without losing generality. The switching frequency is 100 kHz. The deadtime of the switching signal is 0.1 μs. PI controllers are adopted for both current and voltage control. The parameters of the current controller are K_{Pi}=1 and Kᵢᵢ=100000 and the parameters of the voltage controller are K_{PV}=0.1 and K_{iV}=10000. The output current and voltage references are I_{bref}=1.675A and V_{bref}=4.2V. Two cases are investigated in simulation. In case 1, the output current is controlled to track the current reference with the phase shift angle being greater than 120°. In case 2, the output voltage is controlled to track the voltage reference with the phase shift angle being greater than 165°, which means the on-pulse width of the input voltage of the transmitter (i.e., vₚ) is less than 15°.

TABLE 1
Main Parameters of WPT System in Simulation

| | | | |
|---|---|---|---|
| Parameters | Value | Parameters | Value |

| | | | | | |
|---|---|---|---|---|---|
| V_{dc} | 24 | V | Lₚ | 48.4 | μH |
| Lₛ | 48.4 | μH | M | 7.1 | μH |
| Cₚ | 52.3 | nF | Cₛ | 52.3 | nF |
| Rₚ | 0.1 | Ω | Rₛ | 0.1 | Ω |
| C_{f} | 20 | μF | R_{L} | 10 | Ω |
| C₁ | 1 | nF | C₂ | 1 | nF |
| C₃ | 1 | nF | C₄ | 1 | nF |
| C_{A1} | 100 | nF | C_{A2} | 100 | nF |

| | | |
|---|---|---|
| L_{A} | 1 | μH |

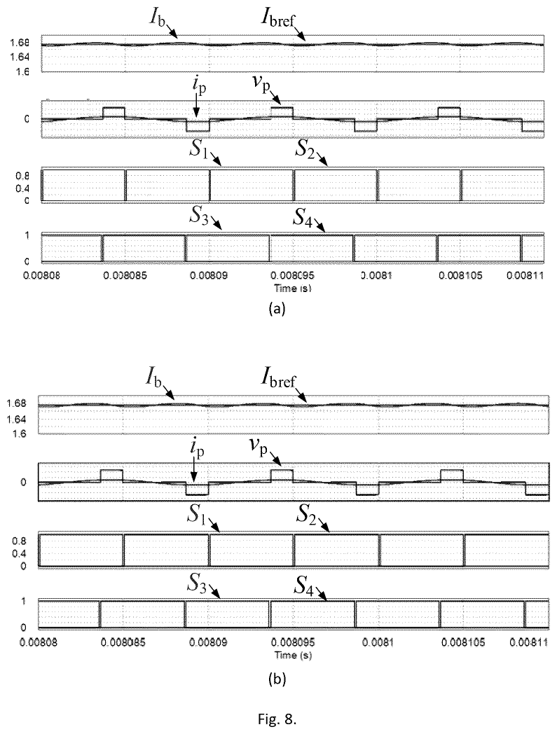

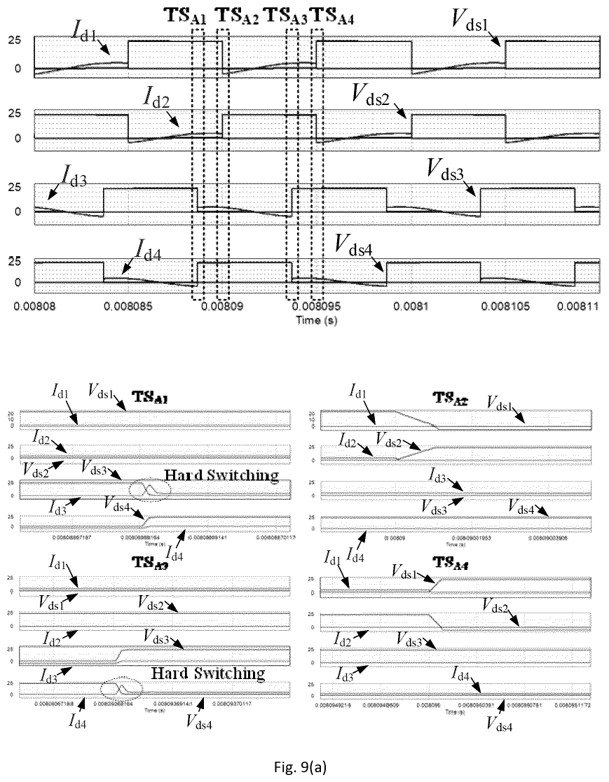

For case 1, the waveforms of the output current (i.e., I_{b}), output current reference (i.e., I_{bref}), transmitter current (i.e., iₚ), input voltage of the transmitting resonator (i.e., vₚ), and the four switching signals (i.e., S₁, S₂, S₃, and S₄) of the WPT system without the augmented circuit (known WPT system) and with the augmented circuit are shown in FIG. 8. Both output currents are well-regulated to track the current reference (i.e., I_{bref}=1.675 A), and the transmitter currents are in phase with the input voltages of the transmitting resonators. The phase shift angles between the diagonal switching signals are controlled at 131.8° and 129.2° for the WPT systems without the augmented circuit and with the augmented circuit, respectively.

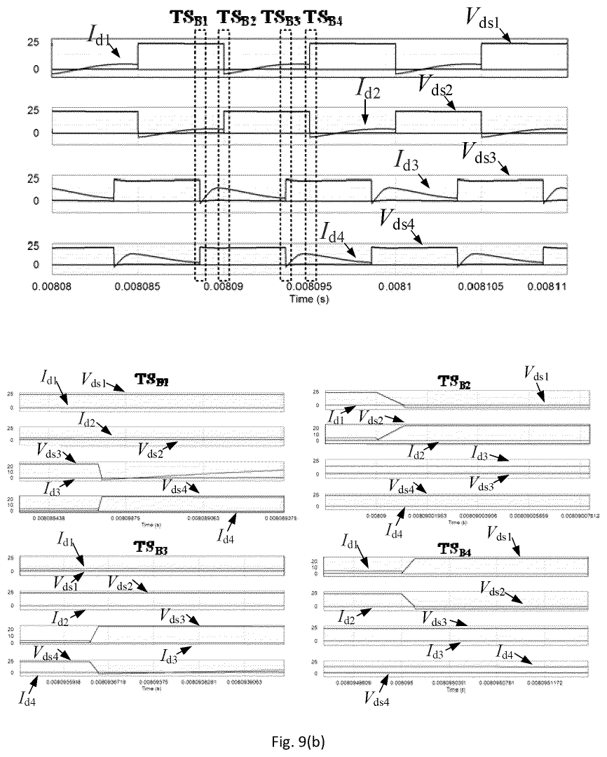

The waveforms of corresponding drain currents (i.e., I_{d1}, I_{d2}, I_{d3}, and I_{d4}) and drain-to-source voltages (i.e., V_{ds1}, V_{ds2}, V_{ds3}, and V_{ds4}) of the four switches are shown in FIG. 9. The four transient periods are labelled as TS_{A1}, TS_{A2}, TS_{A3}, and TS_{A4} for the WPT system without the augmented circuit, and the transient periods are labelled as TS_{B1}, TS_{B2}, TS_{B3}, and TS_{B4} for the WPT system with the augmented circuit. Apparently, hard switching occurs on the lagging bridge leg (i.e., φ₃ and φ₄) of the WPT system without the augmented circuit during TS_{A1} and TS_{A3}, respectively. However, ZVS can be implemented for all the four switches of the WPT system with the augmented circuit.

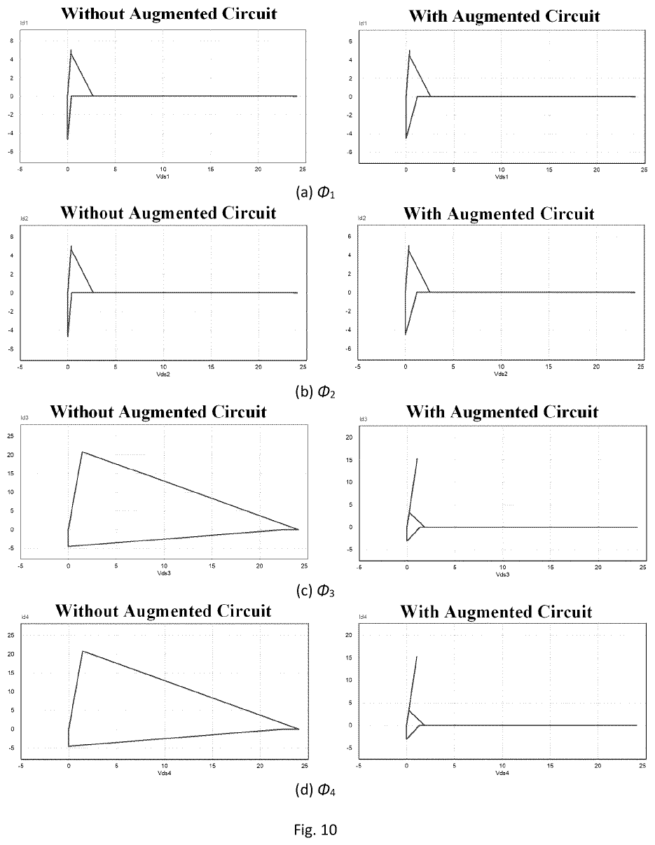

The corresponding V_{ds}-I_{d} curves of the switches of the WPT system without and with the augmented circuit are plotted, as shown in FIG. 10. It is clear to observe that the enclosed areas of φ₃ and φ₄ of the WPT system with the augmented circuit are significantly shrunk. The hard-switching issue of φ₃ and φ₄ for the known WPT system with phase shift control is addressed by incorporating the augmented circuit.

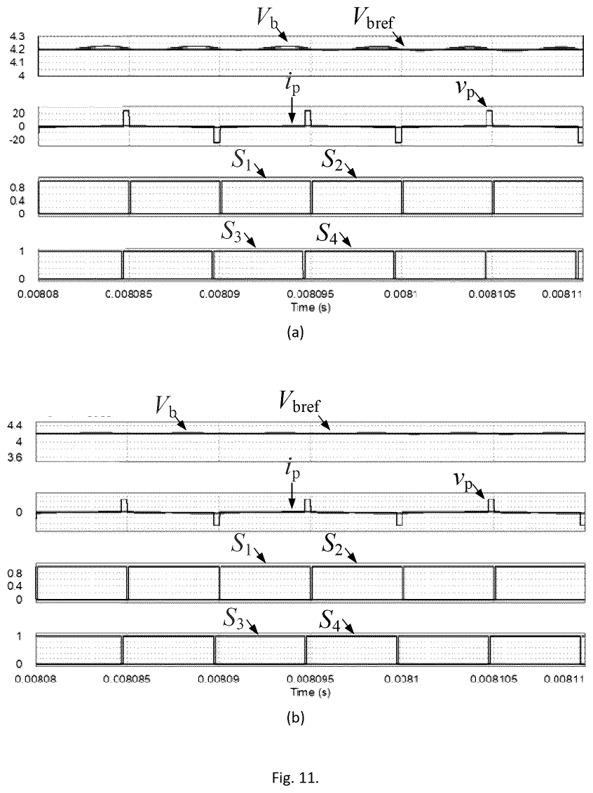

For case 2, the waveforms of the output voltage (i.e., V_{b}), output voltage reference (i.e., V_{bref}), transmitter current (i.e., iₚ), input voltage of the transmitting resonator (i.e., vₚ), and the four switching signals (i.e., S₁, S₂, S₃, and S₄) of the WPT system without the augmented circuit (known WPT system) and with the augmented circuit are shown in FIG. 11. He output voltages are regulated to track the reference (i.e., V_{bref}=4.2 V). The phase shift angle between the diagonal switching signals is controlled at 165.4° and 169.2° for the WPT system without and with the augmented circuit, respectively.

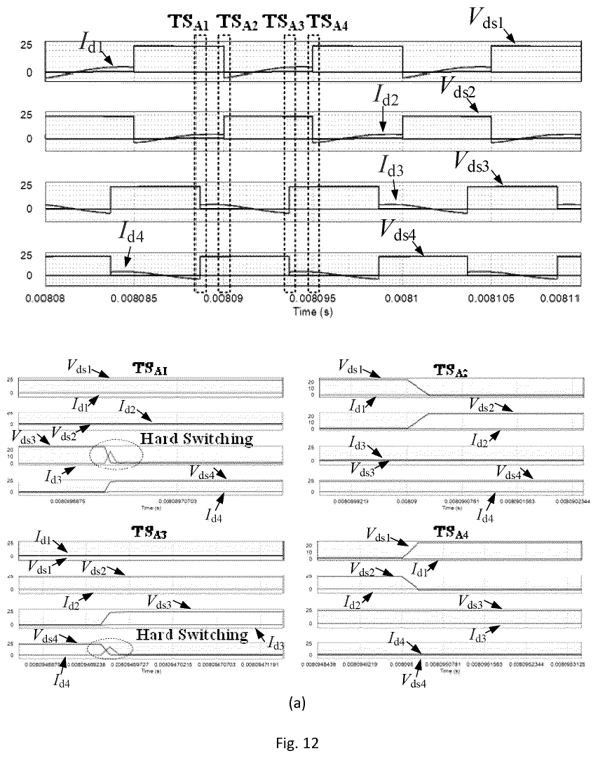

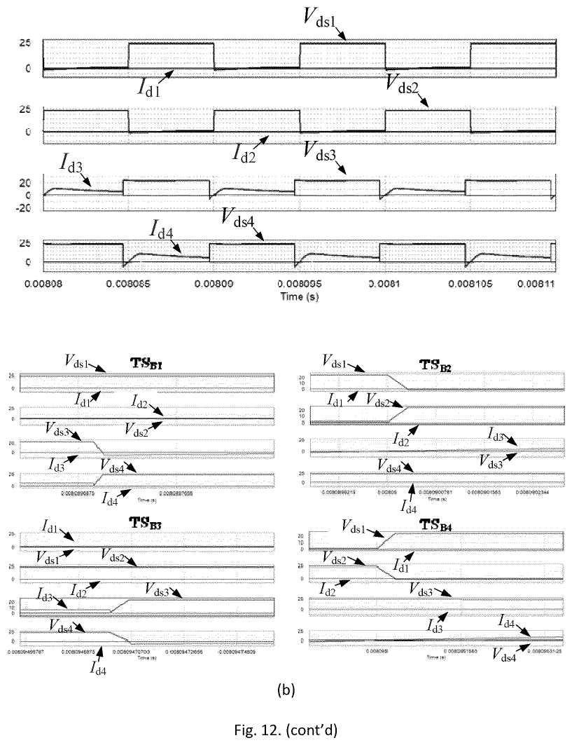

The corresponding V_{ds}-I_{d} curves of the switches of the WPT system without and with the augmented circuit are plotted, are shown in FIG. 12. Similar to the results of case 1, hard switching occurs on the lagging bridge leg of the WPT system without the augmented circuit, while ZVS are implemented for all the switches of the WPT system with the augmented circuit.

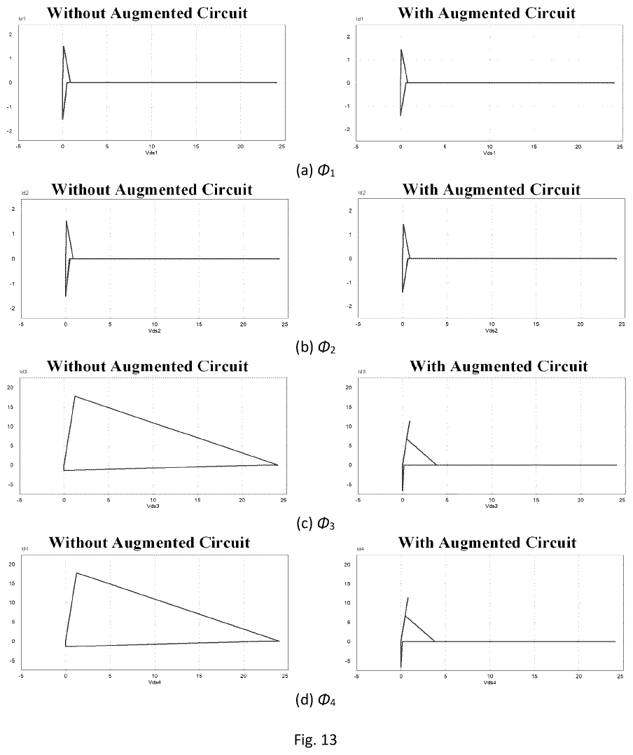

The V_{ds}-I_{d} curves of the switches of the WPT system without and with the augmented circuit are also plotted, as shown in FIG. 13. Similar to the results of case 1, the enclosed areas of φ₃ and φ₄ of the WPT system with the augmented circuit are significantly shrunk.

### Experimental Verification

Experiments are conducted on a WPT system with the same parameters, as given in Table 1. The frequency and deadtime of the switching signals of the full-bridge inverter are also identical to those being used in the simulation. The MOSFETs of the full-bridge inverter is Infineon's IRFP250M. Rogowski coils are adopted to measure the drain currents of the four DIP MOSFETs. The conducted EMI of the full-bridge inverter are measured by Advantest's spectrum analyzer R3261C. Background EMIs of the EMC chamber are shown in “Further Data, Section A” below. RIGOL's DP832 is adopted as the DC power supply for the WPT system. The controller is implemented using Texas Instrument (TI)'s digital signal processor (DSP) TMS320F28335. The parameters of the current controller are K_{PI}=0.00001 and K_{iI}=0.1 and the parameters of the voltage controller are K_{PV}=0.00001 and K_{iV}=10000. The output current and voltage references are also I_{bref}=1.675A and V_{bref}=4.2V. In experiment, both CC and CV control are studied.

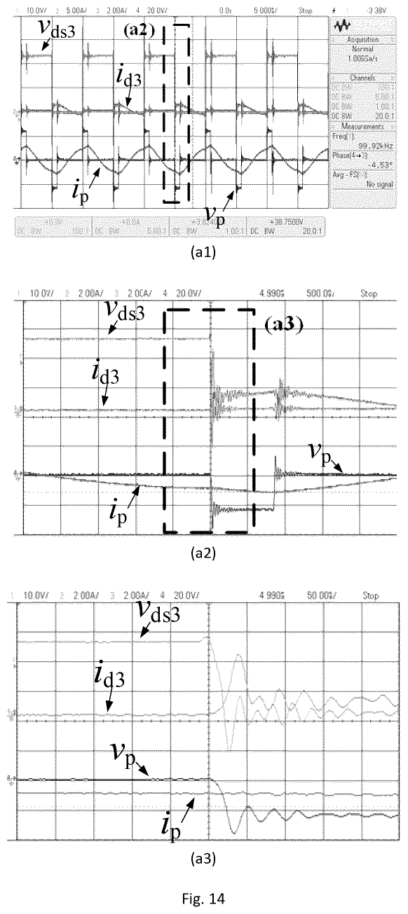

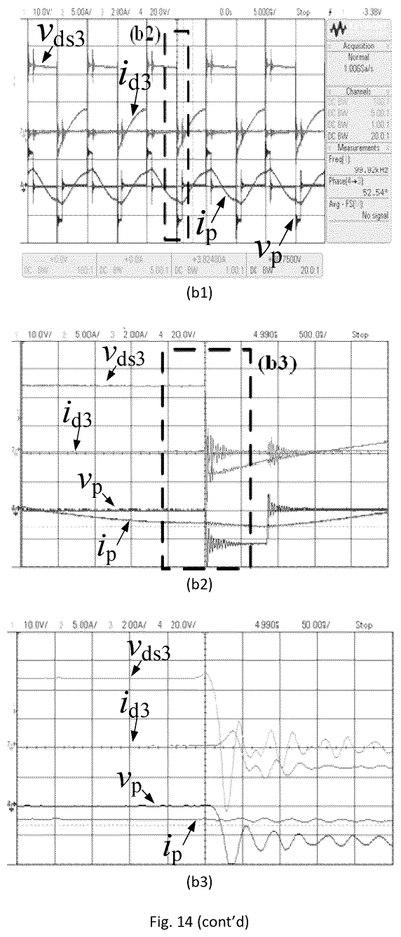

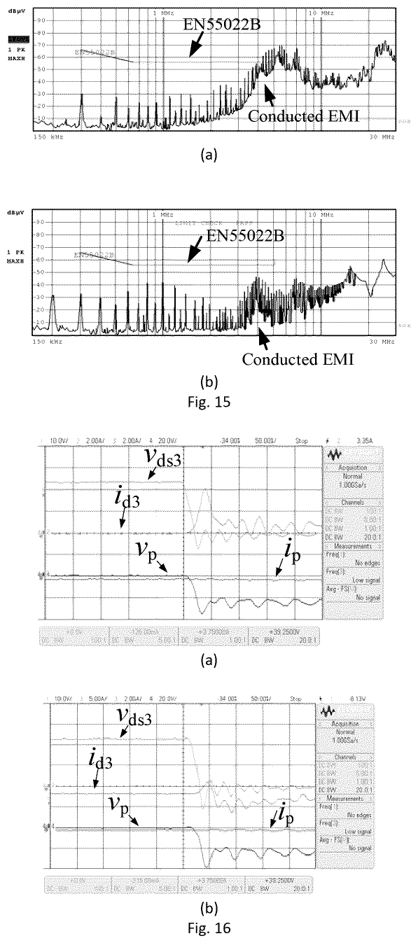

First, the output current of the WPT system (i.e., I_{b}) is controlled to track the reference (i.e., I_{bref}) at 1.675 A. The waveforms of drain-to-source voltages and drain currents of the switch φ₃ (i.e., v_{ds3} and i_{d3}), transmitter currents (i.e., iₚ), and input voltages of the transmitting resonators (i.e., vₚ) for the WPT system without and with the augmented circuit are shown in FIG. 16. The phase shift angles are controlled at 148.6° for the WPT system without the augmented circuit and at 148.2° for the WPT system with the augmented circuit. The waveforms in FIGS. 14(a2) and (b2) are magnified from the waveforms in FIGS. 14(a1) and (b1), respectively. The waveforms in FIGS. 14(a3) and (b3) are magnified from the waveforms in FIGS. 14(a2) and (b2), respectively. The waveforms of v_{ds3} and i_{d3} in FIG. 14(a3) show that hard switching occurs for the known WPT system without the augmented circuit. However, ZVS can be achieved when the augmented circuit is integrated into the full-bridge inverter, as shown in FIG. 14(b3). Comparisons of conducted EMI from 150 kHz to 30 MHz between the full-bridge inverter without and with the augmented circuit are shown in FIG. 15. Apparently, the conducted EMI of the full-bridge inverter without the augmented circuit exceeds the upper limit of the standard EN55022. By incorporating the augmented circuit, the conducted EMI of the full-bridge inverter is significantly mitigated below the upper limit.

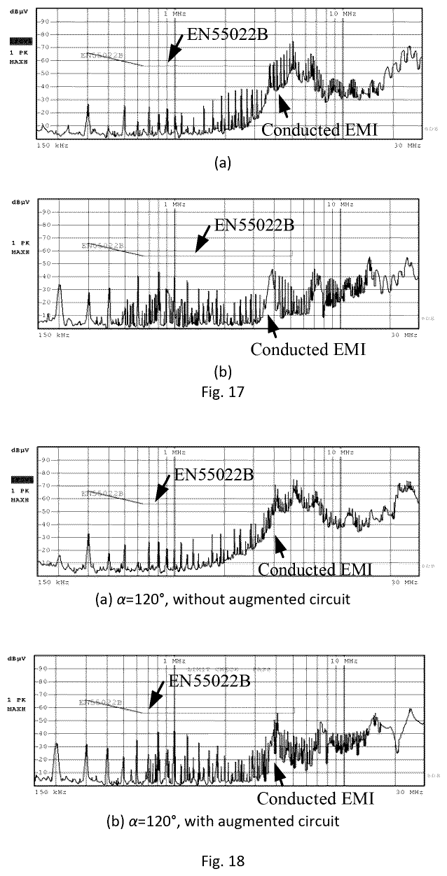

Then, the output voltage of the WPT system (i.e., V_{b}) is controlled to track the reference (i.e., V_{bref}) at 4.2 V. The phase shift angles are controlled at 166.2° and 169.8° for the WPT system without and with the augmented circuit, respectively. The comparisons of the magnified waveforms of v_{ds3} and i_{d3} within a 0.5 μs transient state between the full-bridge inverters with and without the augmented circuit, are shown in FIG. 16. The magnified waveforms show that the hard switching occurs for the known WPT system without the augmented circuit, while ZVS can be achieved by integrating the augmented circuit, even if the phase shift angle has reached about 1700 (i.e., the on-pulse width of vₚ is only about 10°). Comparisons of conducted EMI from 150 kHz to 30 MHz between the full-bridge inverter without and with the augmented circuit are shown in FIG. 17. Obviously, the conducted EMI of the full-bridge inverter without the augmented circuit also exceeds the upper limit of the standard EN55022 for the voltage control. However, by integrating the augmented circuit, the EMI can be dramatically reduced.

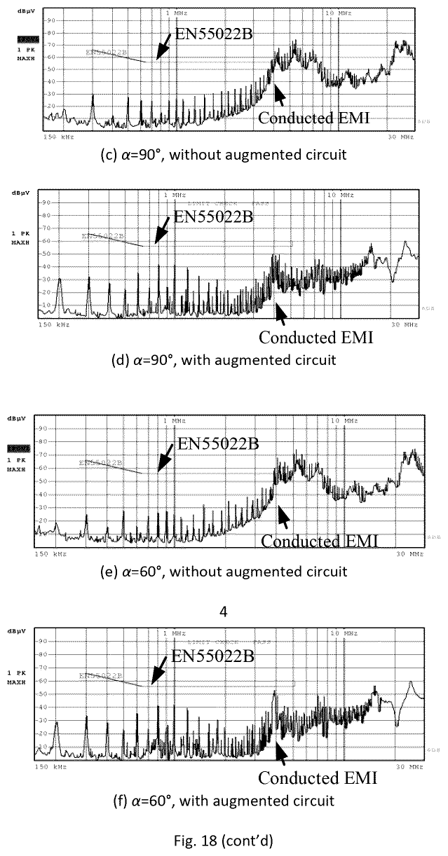

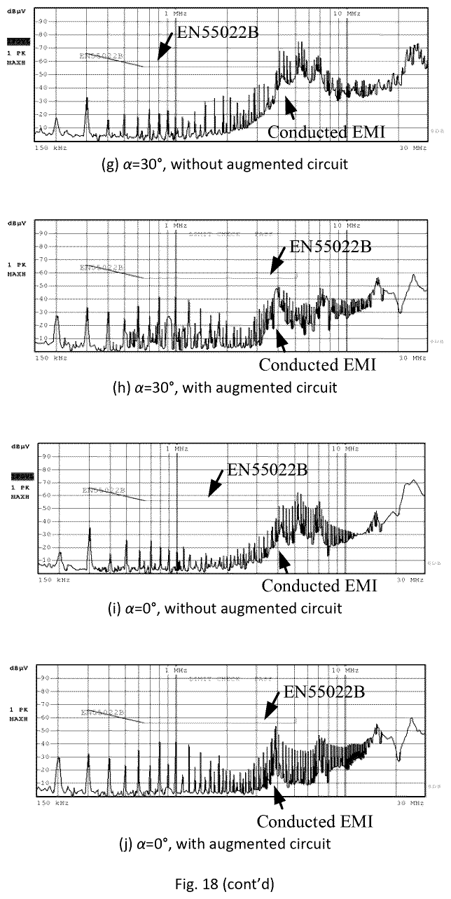

Similar experiments are also conducted on the WPT system with the phase shift angle of 120°, 90°, 60°, 30°, and 0°, respectively. The corresponding waveforms of v_{ds3}, i_{d3}, iₚ, and vₚ for the WPT system without and with the augmented circuit are shown in “Further data, Section B” below. The results reveal that the augmented circuit can also achieve ZVS for heavy load conditions. The corresponding conducted EMI of the full-bridge inverter without and with the augmented circuit are presented in FIG. 18. Obviously, conducted EMIs are mitigated by the augmented circuit for the heavy load conditions. However, it is worthy to note that the EMI reduction is more significant for the WPT system with a lager phase shift angle.

### Further Data

### A. Background EMIs of the EMC Chamber

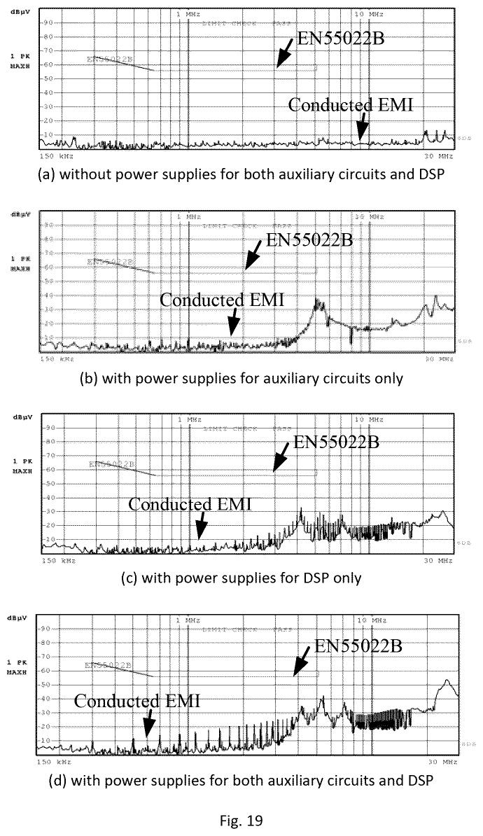

Since both the full-bridge inverter and controller circuit are placed inside the test chamber, four background EMIs, including (i) the conducted EMI without the power supplies for auxiliary circuits of the full-bridge inverter and the controller circuit, (ii) the conducted EMI with the power supplies for auxiliary circuits of the full-bridge inverter but without the controller circuit, (iii) the conducted EMI without the power supplies for auxiliary circuits of the full-bridge inverter but with the controller circuit, and (iv) the conducted EMI with the power supplies for auxiliary circuits of the full-bridge inverter, are measured as references, as shown in FIG. 19.

B. Waveforms of v_{ds3}, i_{d3}, iₚ, and vₚ of the WPT Systems with Different Phase Shift Angles

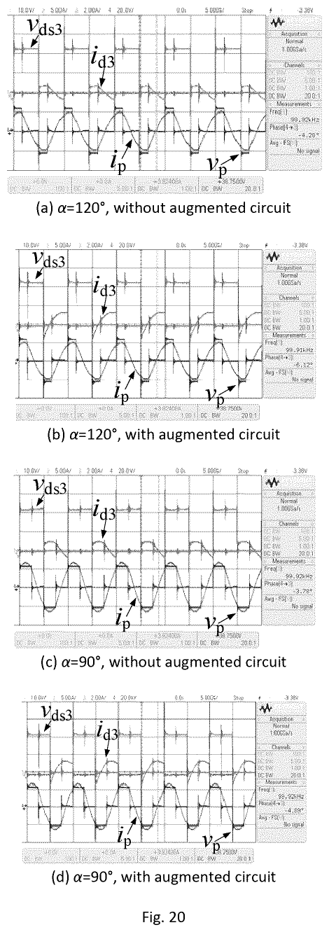

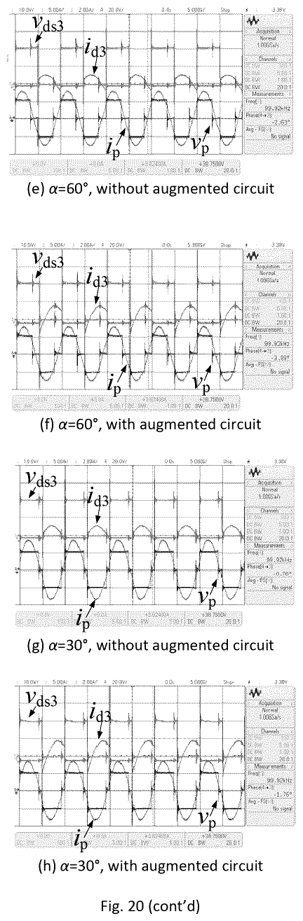

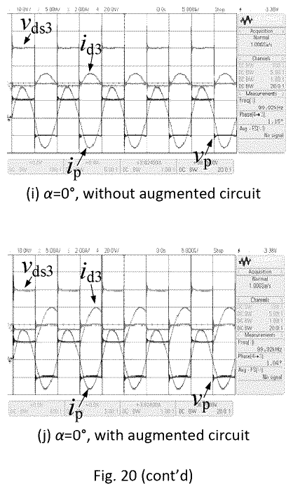

Experimental waveforms of v_{ds3}, i_{d3}, iₚ, and vₚ of the full-bridge inverter without and with the augmented circuit for the phase shift angle at 120°, 90°, 60°, 30°, and 0° are shown in FIG. 20.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

The current application also describes the following concepts.
1 An augmented passive circuit (with connections shown in FIG. 5) comprising two diodes, two capacitors and one inductor for achieving soft switching in all the power switches in a power inverter under phase-shift modulation control.
2 The augmented passive circuit can be added to a power inverter to achieve soft switching under either fixed-frequency or variable-frequency operations of power inverter.
3 The augmented passive circuit can reduce the switching power stress and power losses to improve the lifetime and conversion efficiency of power inverters.
4 The augmented passive circuit can be used to modify existing designs of wireless power transfer systems compliant with the standards of the Wireless Power Consortium and Society of Automotive Engineers without changing the control algorithms.
5 The augmented passive circuit can be transformed as an augmented active circuit by replacing the inductor with an actively-controlled current source or an equivalent current source, while still maintaining the functions described in the above points 2 to 4.
6 A design method for the augmented passive circuit based on the equations (25) to (27).

### REFERENCES

[1]M. Jonanovic, W. Tabisz and F. C. Lee, “Zero-voltage-switching technique in high-frequency off-line converters”, IEEE Applied Power Electron. Conf., pp: 23-32, March 1988
[2]J. A. Sabate, V. Vlatkovic, R. B. Ridley, F. C. Lee; B. H. Cho, “Design considerations for high-voltage high-power full-bridge zero-voltage-switched PWM converter”, IEEE Applied Power Electron. Conf., pp: 275-284, March 1990
[3] R. Redl, N. O. Sokal; L. Balogh, “A novel soft-switching full-bridge DC/DC converter: analysis, design considerations, and experimental results at 1.5 kW, 100 kHz”, IEEE Applied Power Electron. Conf., pp: 162-172, March 1990
[4] X. H. Cao and S. Y. R. Hui, “Soft-switching techniques for power inverter legs,” U.S. Pat. No. 7,110,269, Sep. 19, 2006.
[5]P. Jain, “Resonant power conversion: insights from a lifetime of experience”, IEEE Journal of Emerging and Selected Topics in Power Electron., (Early Access)
[6]P. K. Jain, H. Soin and M. Cardella, “Constant frequency resonant dc/dc converter topologies with zero switching losses”, IEEE Trans. Aerospace and Electron. Sys., Vol. 30, No. 2, pp:534-544, April 1994
[7]D. Tschirhart and P. Jain, “Design procedure for high-frequency operation of the modified series-resonant APWM converter to reduce size and circulating current”, IEEE Trans. Power Electron., vol. 27, no. 10, pp. 4181-4191, October 2012.
[8]H. Kifune, Y. Hatanaka, and M. Nakaoka, “Quasi-series-resonant-type soft-switching phase shift modulated inverter,” IET Proc. Eletric. Power Appl., vol. 150, no. 6, pp. 725-732, November 2003.
[9]H. Matsuo, H. Yonemori, and Y. Yasaka, “Phase-shift controlled zero current switching high frequency inverter in the MHz frequency range,” in 2010 IEEE Int. Power Electron. Conf., pp. 2830-2835, March 2010.
[10] Texas Instruments Design guide: “Phase-shifted full bridge dc/dc power converter design guide”, TIDU248 May 2014
[11]U. Kavimandan, V. Galigekere, B. Ozpineci, O. Onar and S. Mahajan, “The impact of inverter dead-time in single-phase wireless power transfer systems”, IEEE Trans. Power Electron., vol. 37, no. 1, pp. 1074-1089, January 2022.
[12]C. Xia, R. Jia, Y. Shi, A. P Hu and Y. Zhou, “Simultaneous wireless power and information transfer based on phase-shift modulation in ICPT system, IEEE Trans. On Energy Con., Vol. 36, No. 2, pp: 629-639, June 2021
[13]J. Pries, G. Su, V. Galigekere and O. Onar, “Phase shift control of a three-phase inverter for balanced secondary currents in misaligned three-phase inductive power transfer systems, IEEE PELS Workshop on Emerging Technologies: Wireless Power Transfer, Seoul, pp: 10-15, November 2020
[14] Y. Lee, D. Kim, C. Kim and G. Moon, “A new receiver-side integrated regulator with phase shift control strategy for wireless power transfer system”, IEEE PELS Workshop on Emerging Technologies: Wireless Power Transfer, Seoul, pp: 112-115, November 2020
[15]F. Liu, W. Lei, T. Wang, C. Nie and Y. Wang, “A phase-shift soft-switching control strategy for dual active wireless power transfer system”, IEEE Energy Conversion Congress and Exposition (ECCE), pp: 2573-2578, October 2017
[16]Y. Li, W. Sun, X. Zhu and J. Hu, “A hybrid modulation control for wireless power transfer systems to improve efficiency under light-load conditions”, IEEE Trans. On Ind. Electron., Early Access
[17]Y. Guo; Y. Zhang, “Secondary Side Voltage and Current Estimation of Wireless Power Transfer Systems”, IEEE Trans. Ind. Appl. Early Access
[18]L. Yang, Y. Shi, M. Wang and L. Ren, “Constant voltage charging and maximum efficiency tracking for WPT systems employing dual-side control scheme”, IEEE Journal on Emerging and Selected Topics in Power Electron., Early Access
[19]S. Y. R. Hui and Y. Yang, “Battery charging system and method using dynamically adjusted voltage threshold for switching charging modes,” Publication Number: WO/2020/233552, Nov. 26, 2020.
[20]W. Zhong and S. Y. R. Hui, “Maximum energy efficiency tracking for wireless power transfer systems” IEEE Trans. Power Electron., vol. 30, no. 7, pp. 4025-4034, July 2005.

1. A phase-shift modulated full-bridge power inverter configured for use in a wireless power transfer system, the power inverter comprising:
a leading bridge leg comprising:
a first power switch, the first power switch having a first power switch parasitic capacitance; and
a second power switch, the second power switch having a second power switch parasitic capacitance;
a lagging bridge leg comprising:
a third power switch, the third power switch having a third power switch parasitic capacitance; and
a fourth power switch, the fourth power switch having a fourth power switch parasitic capacitance; wherein
the power inverter is configured for each of the power switches to be switched on and off in a switching cycle; and wherein the power inverter further comprises:
an augmented passive circuit comprising an inductor, wherein the power inverter is configured for the inductor to combine with the third power switch parasitic capacitance and the fourth power switch capacitance to form a resonator when a first one of the third and fourth power switches is switched off and a second one of the third and fourth power switches is in a switched off state, and for energy stored in the parasitic capacitance of the second one of the third and fourth power switches to be discharged before the second one of the third and fourth power switches is switched on.

2. The power inverter of claim 1, the augmented passive circuit further comprising a diode circuit branch, the diode circuit branch comprising a first diode and a second diode connected in series with one another, the diode circuit branch being connected in parallel to the leading bridge leg and the lagging bridge leg, the power inverter being configured for, when:
a first one of the first and second power switches is switched on and a second one of the first and second power switches is in a switched off state;
the first one of the third and fourth power switches is in a switched off state and a second one of the third and fourth power switches is in a switched on state; and
for a first one of the first and second diodes to be in a conductive state and a second one of the first and second diodes to be in a non-conductive state; and wherein the power inverter is configured for current in the inductor to become zero, and for the first one of the first and second diodes to be switched to a non-conductive state.

3. The power inverter of claim 2, the augmented passive circuit further comprising a capacitor circuit branch, the capacitor circuit branch comprising a first capacitor and a second capacitor connected in series with one another, the capacitor circuit branch being connected in parallel to the leading bridge leg and the lagging bridge leg, the power inverter being configured for a magnitude of the current in the inductor to increase, for a first one of the first capacitor and the second capacitor to be fully charged and for a second one of the first capacitor and the second capacitor to be fully discharged, and for the second one of the first and second diodes to be switched to a conductive state.

4. A phase-shift modulated full-bridge power inverter configured for use in a wireless power transfer system, the power inverter comprising:
a leading bridge leg;
a lagging bridge leg;
a first output terminal connected from a leading bridge leg connection point in the leading bridge leg;
a second output terminal connected from a lagging bridge leg connection point in the lagging bridge leg; and
an augmented passive circuit comprising:
a capacitor circuit branch, the capacitor circuit branch comprising a first capacitor and a second capacitor connected in series with one another at a capacitor branch connection point, the capacitor circuit branch being connected in parallel to the leading bridge leg and the lagging bridge leg;
a diode circuit branch, the diode circuit branch comprising a first diode and a second diode connected in series with one another at a diode branch connection point, the diode circuit branch being connected in parallel to the leading bridge leg and the lagging bridge leg; and
an inductor connected at a first inductor terminal to the capacitor branch connection point and the diode branch connection point and connected at a second inductor terminal to one of the first and second output terminals.

5. A method of operating a phase-shift modulated full-bridge power inverter in a wireless power transfer system, the power inverter comprising:
a leading bridge leg comprising:
a first power switch, the first power switch having a first power switch parasitic capacitance; and
a second power switch, the second power switch having a second power switch parasitic capacitance;
a lagging bridge leg comprising:
a third power switch, the third power switch having a third power switch parasitic capacitance;
a fourth power switch, the fourth power switch having a fourth power switch parasitic capacitance; and
an augmented passive circuit comprising an inductor;
the method comprising:
operating the power inverter so that each of the power switches is switched on and off in a switching cycle; and
switching a first one of the third and fourth power switches off when a second one of the third and fourth power switches is in a switched off state, for the inductor to combine with the third power switch parasitic capacitance and the fourth power switch capacitance to form a resonator and discharging energy stored in the parasitic capacitance of the second one of the third and fourth power switches before the second one of the third and fourth power switches is switched on.

6. The method of claim 5, wherein the augmented passive circuit further comprises a diode circuit branch, the diode circuit branch comprising a first diode and a second diode connected in series with one another, the diode circuit branch being connected in parallel to the leading bridge leg and the lagging bridge leg, the method further comprising:
switching a first one of the first and second power switches on when a second one of the first and second power switches is in a switched off state, and when the first one of the third and fourth power switches is in a switched off state and a second one of the third and fourth power switches is in a switched on state; wherein a first one of the first and second diodes is in a conductive state and a second one of the first and second diodes is in a non-conductive state; wherein the power inverter current in the inductor becomes zero, the method further comprising switching the first one of the first and second diodes to a non-conductive state.

7. The method of claim 6, wherein the augmented passive circuit further comprises a capacitor circuit branch, the capacitor circuit branch comprising a first capacitor and a second capacitor connected in series with one another, the capacitor circuit branch being connected in parallel to the leading bridge leg and the lagging bridge leg, the method further comprising increasing a magnitude of the current in the inductor and charging fully a first one of the first capacitor and the second capacitor and discharging fully a second one of the first capacitor and the second capacitor, and switching the second one of the first and second diodes to a conductive state.

8. A method of fitting an augmented passive circuit to a phase-shift modulated full-bridge power inverter configured for use in a wireless power transfer system, the power inverter comprising:
a leading bridge leg;
a lagging bridge leg;
a first output terminal connected from a leading bridge leg connection point in the leading bridge leg; and
a second output terminal connected from a lagging bridge leg connection point in the lagging bridge leg; the method comprising:
connecting a capacitor circuit branch in parallel to the leading bridge leg and the lagging bridge leg, the capacitor circuit branch comprising a first capacitor and a second capacitor connected in series with one another at a capacitor branch connection point;
connecting a diode circuit branch in parallel to the leading bridge leg and the lagging bridge leg, the diode circuit branch comprising a first diode and a second diode connected in series with one another at a diode branch connection point; and
connecting an inductor at a first inductor terminal to the capacitor branch connection point and the diode branch connection point and connecting the inductor at a second inductor terminal to one of the first and second output terminals.

9. A kit of augmented passive circuit parts for fitting to a phase-shift modulated full-bridge power inverter configured for use in a wireless power transfer system, the kit of augmented passive circuit parts comprising:
a first capacitor and a second capacitor to be connected in series with one another at a capacitor branch connection point in a capacitor circuit branch, the capacitor circuit branch to be connected in parallel to a leading bridge leg and a lagging bridge leg of the power inverter;
a first diode and a second diode to be connected in series with one another at a diode branch connection point in a diode circuit branch, the diode circuit branch to be connected in parallel to the leading bridge leg and the lagging bridge leg; and
an inductor to be connected at a first inductor terminal to the capacitor branch connection point and the diode branch connection point and to be connected at a second inductor terminal to one of power inverter first and second output terminals.
